(19) United States
(12) Patent Application Publication
(10) Pub. No.: US 2002/0038247 A1
(43) Pub. Date: Mar. 28, 2002

(54) Method of producing advertisement information, method of producing program, method of executing program, method of supplying reward data, method of judging output of reward data

(76) Inventors: Toru Kambayashi, Chigasaki-shi (JP); Yasushi Kawakura, Yokohama-shi (JP); Yoshihiro Ohmori, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/956,152

(22) Filed: Sep. 20, 2001

(30) Foreign Application Priority Data
Sep. 22, 2000 (JP) 2000-288128

(51) Int. Cl. G06F 17/60

(52) U.S. Cl. 705/14

(57) ABSTRACT

A method of producing advertisement information comprising producing event information for presenting advertisement during an execution of a program, reward data for supplying an additional function to the program and event identification information for identifying the reward data and the event information, outputting the event information and the event identification information which correspond to each other, and outputting the reward data and the event identification information which correspond to each other.

### CROSS-REFERENCE TO RELATED APPLICATIONS

This application is based upon and claims the benefit of priority from the prior Japanese Patent Application No. 2000-288128, filed Sep. 22, 2000, the entire contents of which are incorporated herein by reference.

### BACKGROUND OF THE INVENTION

1. Field of the Invention

The present invention relates to an advertisement system for preferably supplying electronic advertisement.

2. Description of the Related Art

Conventionally, on a part of the WWW home page, a banner advertisement is practiced in which a commercial advertisement is displayed which includes link addresses (URLS) to different home pages which are desired to be referred to by users so that a desired home page is displayed when the users click the area of the advertisement.

There is also available a method of attaching several lines of advertisement document at the beginning of or at the tail of an electronic mail. An advertisement is inserted in news, and messages contributed to mailing lists to be sent, so that mail receivers read the advertisement and accesses to WWW pages from the URL included in the advertisement document.

Furthermore, in the case of a stand-alone computer system without being connected to an Internet as well, a bulletin is displayed on a background on the screen in video games and an actual commercial advertisement is displayed on the bulletin. Advertisement information to be displayed on the game screen is included in the game program in advance, and the advertisement is displayed in accordance with the progress of the game (for example, Japanese Patent KOKAI Publication No. 2000-51519). In this advertisement method, there is provided an exposure effect for forcibly showing the advertisement to potential consumers.

On the other hand, there is available an advertisement method of displaying an advertisement to the effect that a deduction is made when presenting the advertisement to shops, and supplying coupons to attract consumers to visit the shop. In recent years, the coupon is electronically distributed through the WWW and an electronic mail. In this case, consumers print WWW pages and the electronic mail including coupon information, and present the paper to shops to obtain deduction. In this advertisement method, there is provided an effect of attracting consumers to actual shops.

However, in the banner advertisement, the mail advertisement, and the advertisement on the game screen, no direct effect is provided for attracting the consumers to the actual shops and no actual measurement is made on the fact that consumers can be attracted with the advertisement.

On the other hand, in the advertisement using a coupon, some premium can be obtained when consumers visit the actual shops with the result that the shop has an effect of attracting customers to shops. Thus, when the coupon includes information which enables differentiation on an advertisement medium, an actual measurement can be made as to from which advertisement consumers obtain the coupons and visit the shops. However, in the advertisement using the coupon, no exposure effect is provided for forcibly showing the coupon itself to consumers.

### BRIEF SUMMARY OF THE INVENTION

An object of the present invention is to provide a preferable electronic advertisement with both an exposure effect and an attracting effect, and to reproduce the provided electronic advertisement.

According to an aspect of the present invention, a method of producing advertisement information comprises:

producing event information for presenting advertisement during an execution of a program, reward data for supplying an additional function to the program and event identification information for identifying the reward data and the event information;

outputting the event information and the event identification information which correspond to each other; and

outputting the reward data and the event identification information which correspond to each other.

Since the event information and the reward data are identified with the event ID information, the reward data corresponding to the event information can be supplied without any special consciousness even if they are to be supplied to different persons.

According to another aspect of the present invention, a method of producing advertisement information comprises:

inputting a program which does not include advertisement information;

inputting event information for presenting an advertisement, and event identification information for identifying the input event information; and

inserting, at a predetermined position of the program, the event information, the event identification information and a command for writing out the event identification information to a memory device detachably connected to a program execution apparatus.

According to still another aspect of the present invention, a method of executing a program, comprising:

presenting an advertisement to a user based on event information included in a program during an execution of the program; and

outputting event identification information corresponding to the event information to an outside of a program executing apparatus.

Since the event identification information which corresponds to the advertisement is output when the advertisement is presented, the user can alleviate a troublesome processing for obtaining the reward data.

According to still further aspect of the present invention, a method of supplying reward data, comprising:

inputting event identification information and reward data which correspond to each other;

storing the input event identification information and reward data;

reading event identification information from a detachable memory device to compare the read event identification information with the stored event identification information; and

reading the stored reward data corresponding to the read event identification information to write the read reward data into the detachable memory device when the read event identification information coincides with the stored event identification information.

In this manner, the corresponding reward data can be provided only to the user attracted by the advertisement.

According to still another aspect of the present invention, an advertisement method comprising:

producing event information for producing advertisement to be presented during an execution of a program, reward data for supplying an additional function to the program and event identification information for identifying the event information and the reward data;

inserting the event information and the event identification information which correspond to each other into the program;

writing the event identification information and event information which are correspond to each other into a detachable memory device;

outputting, when advertisement is presented based on the event information during the execution of the program, the event identification information which corresponds to the event information; and

supplying the reward data which corresponds to the event information to an owner of the detachable memory device storing the event identification information which coincides with the output event identification information.

Through such procedure, even after the reward data is already output, a supply condition of the reward data can be changed in accordance with the situation.

According to still further aspect of the present invention, an article of manufacture comprising a computer usable medium having computer readable program code means embodied therein, the computer readable program code means comprising:

computer readable program code means for causing a computer to produce event information for presenting advertisement during an execution of a program, reward data for supplying an additional function to the program and event identification information for identifying the reward data;

computer readable program code means for causing a computer to output the event information and the event identification information which correspond to each other;

computer readable program code means for causing a computer to output the reward data and the event identification information which correspond to each other.

As a consequence, the user can alleviate a troublesome processing of obtaining reward data when the advertisement is presented.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a schematic structure of the whole system of an advertisement system according to a first embodiment of the present invention;

FIG. 2 is a flowchart showing a general operation of the whole system according to the first embodiment;

FIG. 3 is a flowchart showing a general operation of the whole system according to the first embodiment;

FIG. 4 is a functional block diagram showing an event data production apparatus;

FIG. 5 shows an event data format;

FIG. 6 shows a format of event ID information and event data output from the event data production apparatus to a program production apparatus;

FIG. 7 shows a format of event ID information and reward data output from the event data production apparatus to a shop apparatus;

FIG. 8 is a flowchart showing an event data production operation in the event data production apparatus;

FIG. 9 is flowchart showing an operation of outputting produced event data;

FIG. 10 is a functional block diagram showing a program production apparatus;

FIG. 11 is a flowchart showing an operation of the program production apparatus;

FIG. 12 is a functional block diagram showing a program executing apparatus and a portable memory device;

FIG. 13 is a functional block diagram showing the shop apparatus;

FIG. 14 is a flowchart showing an operation of the program execution apparatus;

FIG. 15 shows a format of event ID information which is written into the portable memory device by the program executing apparatus;

FIG. 16 is a flowchart showing an operation of storing reward data output from the event data production apparatus;

FIG. 17 is a flowchart showing an operation of providing reward data by the shop apparatus;

FIG. 18 shows a format of the reward data which is written into the portable memory device by the shop apparatus;

FIG. 19 is a flowchart showing an operation of resuming the program execution by the program execution apparatus;

FIG. 20 is a functional block diagram showing a summation apparatus;

FIG. 21 is a table showing event data and reward data in a scenario;

FIG. 22 shows produced three items of event data;

FIG. 23 shows reward data which are obtained based on the event data of FIG. 22;

FIG. 24 is a diagram showing the whole system of an advertisement system according to a second embodiment of the present invention;

FIG. 25 is a functional block diagram showing an event data production apparatus;

FIG. 26 shows a format of event data produced by the event data production apparatus;

FIG. 27 shows a format of reward data at the time when the event data is output from the event data production apparatus;

FIG. 28 is a flowchart showing an operation of producing event data;

FIG. 29 is a flowchart showing an operation of outputting the event data from the event production apparatus;

FIG. 30 is a functional block diagram showing an event control apparatus;

FIG. 31 is a flowchart showing an operation of storing the reward data by the event control apparatus;

FIG. 32 is a flowchart showing an operation of inputting the reward data to the event control apparatus;

FIG. 33 is a flowchart showing an operation of allowing the event control apparatus to make a request of summation to a summation apparatus;

FIG. 34 is a functional block diagram showing a shop apparatus;

FIG. 35 is a functional block diagram showing the summation apparatus; and

FIG. 36 is a flowchart showing an operation of the event control apparatus and the shop apparatus.

### DETAILED DESCRIPTION OF THE INVENTION

An embodiment of an advertisement system according to the present invention will now be described with reference to the accompanying drawings.

With the advertisement system, a program producer or creator who produces or creates a software program, a plurality of shop owners who make a request for advertisement on goods or the like, a scenario producer who provides a method of presenting an advertisement upon receipt of a request of the advertisement from the shop owners, and an infinite number of users who use the software produced by the program producer are associated.

The scenario producer concludes a contract or the like for carrying an advertisement on software programs with the program producer so that the scenario producer obtains a right of carrying an advertisement on programs and a right of obtaining information on useful items in the programs when needed. Furthermore, the scenario producer concludes a contract with owners of shops on which the producer desired to carry an advertisement to obtain advertisement information. The scenario producer produces a scenario on a method of providing an advertisement based on each of rights obtained from the program producer and information associated with the advertisement obtained from shops.

Here, terms used in this specification will be described hereinbelow.

The scenario refers to a plan of inducing users of a program to do a series of behavior on the presupposition of a method of providing fascination for allowing users to visit shops on which the presented advertisement is provided, and an advertisement presentation order to users in the case where two or more advertisements are presented. For example, the plan goes as follows: the user goes to shop A after seeing the first advertisement presented during the execution of the software program. The user obtains reward data (information on useful items in the program) A for visiting the shop from the shop A. The reward data A includes advertisement on shops B and C. The user brings the reward data A back home, and resumes the program by using the reward data A. During the execution of the program, the advertisements on the shops B and C are displayed, so that the user visits the shops B and C. The user brings back reward data B and C obtained from the shops B and C back home and resumes the execution of the program by using the reward data B and C.

In the production of the scenario, it is important to induce the user to visit the shop which presents an advertisement. In order to induce the user to do so, it is so constituted that reward data is given when the user visits the shop. As the reward data, for example, items useful for the progress of the program, a different advertisement greatly useful for the user and a combination thereof are given when the user visits the shop. When the different advertisement is included in the reward data, there is a possibility that the user visits the next shop, and the plan continues.

When only items useful for the progress of the program are supplied, the plan which allows the user to visit the shop is completed.

The scenario goes as described above. That is, the scenario is produced by a combination of two points; presenting an advertisement to the user and providing a pleasant reward to the user so as to allow the user to visit the shops.

The event refers to an act of presenting an advertisement to the user. Here, the event refers to a series of advertisement acts accompanied by the display of the names of the shops, maps, and messages and sounds such as announcement and effect sounds or the like at a specific timing in the execution of the program.

The event data refers to data produced so that the user can act in accordance with the scenario. Normally, with a combination of a plurality of event data, one scenario is produced. The event data is a source of event ID (identification) information, event information and reward data.

The event ID information includes identification information for identifying the event data, namely the name of the event data or the like. The event information refers to data such as documents, images, sounds or the like which are materials for occurring events. The event information for occurring the first event in the scenario is embedded in the game program. On the other hand, the event information for occurring the second event and thereafter is embedded in the reward data. The reward data is information given as reward when the user visits the shop which presents the advertisement thereof. The reward data normally includes item ID and event information. When the reward data does not include the event information, the user who receives the reward data does not receive the provision of the next advertisement in this scenario, so that the scenario ends at this point.

In the software program, in particular, in the game software program, many items are present which are provided as additional functions for favorably executing the programs according to the progress of the program. With respect to the items, at the time of the start of the software program, almost all the functions are turned off (unusable state). A predetermined item is subsequently turned on (usable state) by executing a certain operation or act at a certain timing/occasion during the progress of the program with the result that an additional function is provided. The item ID refers to an identifier for identifying the item. Hereinafter, the software program is simply referred to as a program for the sake of simplicity.

The program supplied to the user includes these items, and the timing/occasion of turning on a part of these items is provided to the scenario producer. The scenario producer uses a part of the timing/occasion as the reward data.

As has been explained above, the program producer produces the program with considering supplying a part of the items to the scenario producer. The timing/occasion of turning on these items may be present in the program. In this case, it is desirable that the timing/occasion of turning on the item which is desired to be provided to the scenario producer is included in the program at a position where such timing/occasion can be soon or easily obtained.

### First Embodiment

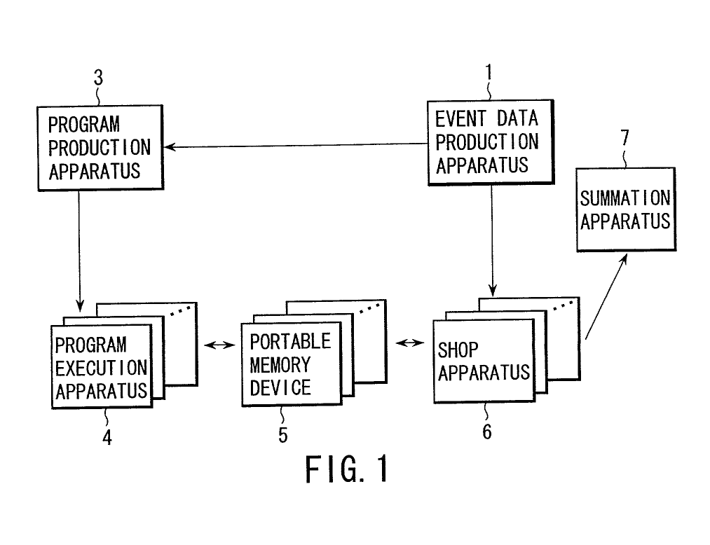

FIG. 1 is a diagram showing a schematic structure of the whole advertisement system according to the first embodiment. An event data production apparatus 1 is used by a scenario producer. The scenario producer produces event data and generates event ID information, event information and reward data based on the produced event data and outputs the event ID information and event information as a set and the event ID information and reward data as a set. The event ID information and event information are output to a program production apparatus 3. The event ID information and reward data are output to shop apparatuses 6.

The program production apparatus 3 is used by the program producer to input the event ID information and event information output from the event data production apparatus 1, and to insert the event ID information and event information supplied from the program production apparatus 1 into a software program produced by the program producer thereby completing a program which can be provided to the user.

Program execution apparatuses 4 for executing the program which is completed by the program production apparatus 3 is possessed by an infinite number of users. The program execution apparatuses 4 execute the program. The program execution apparatuses 4 can be connected to a portable memory device 5 each having a detachable and rewritable memory, and have a function of writing data to the memory of the portable memory device 5 and reading data from the memory. The portable memory device 5 comprises a memory card or floppy disk.

The shop apparatuses 6 are installed at shops posting advertisement provided by the event information. The event ID information and reward data output from the event data production apparatus 1 are input to the shop apparatus 6 and stored therein. Furthermore, the shop apparatus 6 can be connected to the detachable portable memory device 5 in a similar manner as the program execution apparatus 4. When the information of the connected portable memory device 5 satisfies a predetermined condition, the corresponding reward data is written into the portable memory device 5. The information of the connected portable memory device 5 refers to the content of the memory of the portable memory device 5.

Furthermore, the shop apparatus 6 stores information associated with the connected portable memory device 5, and outputs the information. The portable memory device 5 is provided with a device ID peculiar to each device.

A summation apparatus 7 has a function of receiving an output of information associated with the portable memory devices 5 which are stored in the shop apparatuses 6 so that information can be summed in various method.

It is so constituted that each item of the above information can be received from the event data production apparatus 1 to the program production apparatus 3, from the program production apparatus 3 to the program execution apparatuses 4, from the event data production apparatus 1 to the shop apparatuses 6 and from the shop apparatuses 6 to the summation apparatus 7 via the network, the recording medium or the like.

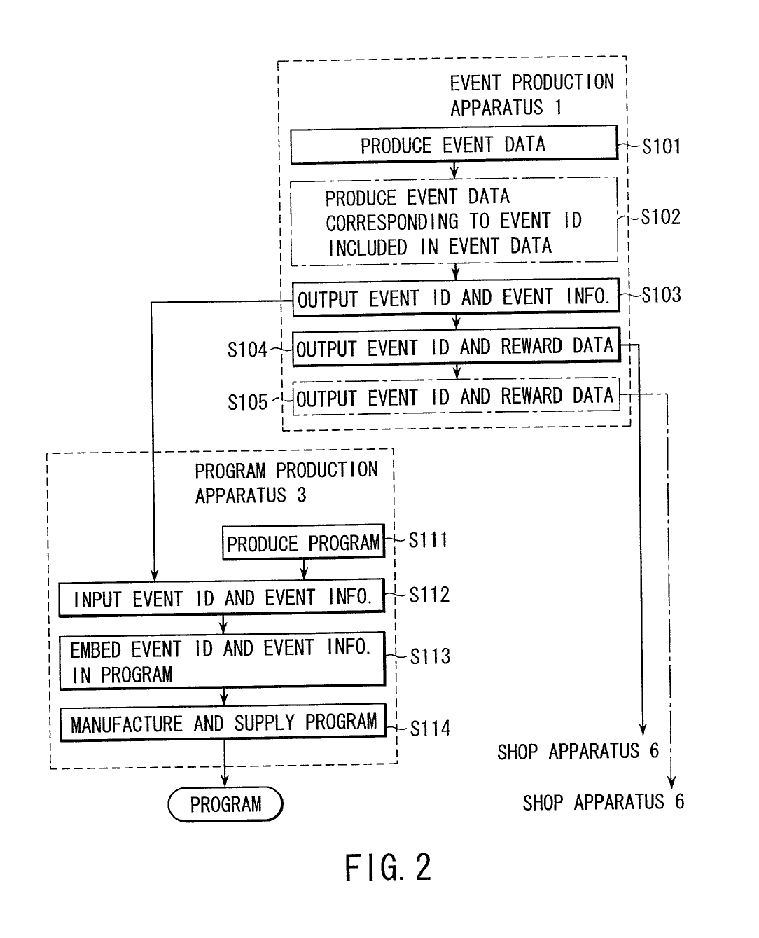

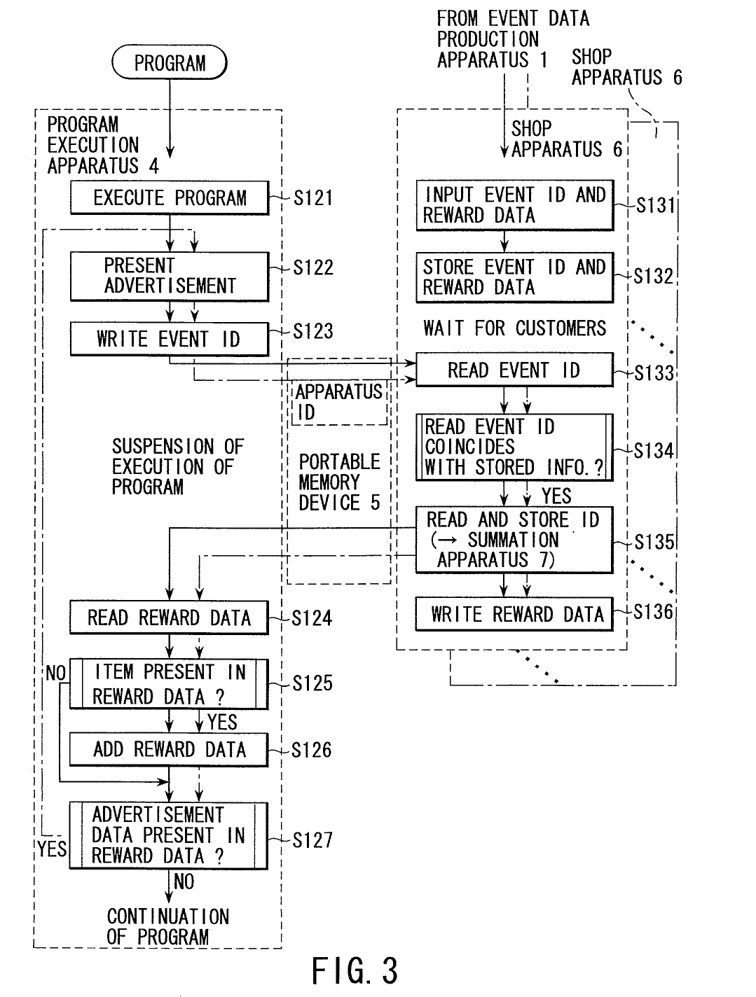

The schematic operation of this system will be shown in the flowcharts of FIGS. 2 and 3 and the operation will be explained.

The scenario producer uses the event data production apparatus 1 to produce the first event data in accordance with the scenario (S101). If the chain-reaction in the presentation of the advertisement is included in the scenario, the following event data is produced (S102). In the absence of the chain-reaction operation, this step S102 is not executed.

The event data production apparatus 1 produces the event ID information and the event information based on the produced event data to supply the set to the program production apparatus 3 (S103). The event data production apparatus 1 produces the event ID information and the reward data based on the produced event data. The event ID information and reward data are supplied to the one specific shop apparatus 6 among the shop apparatuses 6 (S104). The one specific shop apparatus 6 refers to a shop apparatus which is installed at a shop which presents an advertisement on the event information. In supplying the advertisement, the information is stored in a memory medium, for example, a FDD, a memory card or the like to send the information, or data is directly sent via the network depending on the usage environment. Furthermore, at step S102, in the case where the following (and thereafter) event data is produced, the event data production apparatus 1 produces the event ID information and the reward data based on the event information to supply the set to one shop apparatus 6 associated with the event among the shop apparatuses 6 (S105).

The program production apparatus 3 inputs a program (for example, a game) produced by the program producer (S111). Instead of inputting the program produced by the other apparatus in advance, the program may be produced by the apparatus 3. Furthermore, a set of the event ID information and the event information of the program is input from the event data production apparatus 1 at step S103 (S112). Then, the event ID information and the event information are inserted into a specific position of the program (S113). The program into which the event ID information and the event information are inserted is converted (compiled) into an executable program, and is stored in a portable medium such as a CD-ROM, a DVD-ROM or the like to be sold. Otherwise, the program is carried in such a manner that the program can be downloaded to the home page on the Internet to be supplied to the user (S114).

On the other hand, in the shop apparatus 6, as shown in FIG. 3, a set of the event ID information and the reward data output from the event data production apparatus 1 at step S104 is input (S131) and the set is stored in the memory device in the shop apparatus 6 (S132).

Furthermore, in the case where the above step S105 is put into effect at the event data production apparatus 1 (in the case where a set of the following event ID information and the reward data thereafter is output), a set of the event ID information (different from the above event ID information) and the reward data output at the above step S105 is input (S131) so that the set is stored in the memory device in the shop apparatus 6 (S132).

The user procures a program distributed at the program production apparatus 3 (step S114), and the program is executed with the program execution apparatus 4 (S121). When the event information inserted into the program is executed in the course of the execution of the program, the advertisement is presented to the user (S122). The event ID information of this executed event information is written into the detachable portable memory device 5 which is connected to the program execution apparatus 4 in advance (S123). This advertisement is such that, for example, you can obtain a so-and-so item when you visit a so-and-so shop.

The user who sees such advertisement comes to have an idea that he/she wants to visit the shop. Such user detaches the portable memory device 5 on which the event ID information is written from the program execution program 4 and carries the device 5 and visits the shop presenting the advertisement. The user connects the carried portable memory device 5 to the shop device 6 installed at the shop the user visited.

The shop apparatus 6 reads the event ID information from the connected portable memory device 5 (S133).

The shop apparatus 6 determines whether or not the event ID information read from this portable memory device 5 coincides with the event ID information which is already supplied from the event data production apparatus 1 and stored in the memory device in the shop apparatus 6 (S134). This determination includes a meaning that it is confirmed that the user is the user who receives the presentation of the advertisement from the program. When it is confirmed that the read event ID information coincides with the stored event ID information, the shop apparatus 6 reads the apparatus ID peculiar to the portable memory device 5 and stores the ID in the memory device of the shop apparatus 6 (S135). This stored apparatus ID is supplied to the summation apparatus 7 via the medium and the network either instantly or at later days. The shop apparatus 6 writes the reward data (for example, items required for the execution of the game) corresponding to the coincident event ID information into the portable memory device 5 (S136).

The user brings back the portable memory device 5 in which the reward data is written to connect the portable memory device 5 to the program execution apparatus 4. When the user resumes the program, the program execution apparatus 4 reads the reward data from the portable memory device 5 (S124). It is determined whether the read reward data includes information for conducting an additional function to be added to the program (S125). When the information is included therein, the additional function is allowed to be conducted at the program (S126). Thereafter, this additional function can be used at the program.

Furthermore, it is determined whether or not the read reward data includes event information for presenting new advertisement (S127). When it is determined that new advertisement is included therein, the new advertisement is presented to the user (S122), so that the event ID information of the new event information is written into the portable memory device (S123). Carrying this portable memory device 5, the user goes to a shop, which is different from the first shop, presented in the new advertisement.

When the read reward data does not include the event information, no advertisement on the next shop is present. Consequently, the scenario constituted of a series of events is finished.

Next, each apparatus of this system will be explained in detail.

The event data production apparatus 1 will be explained.

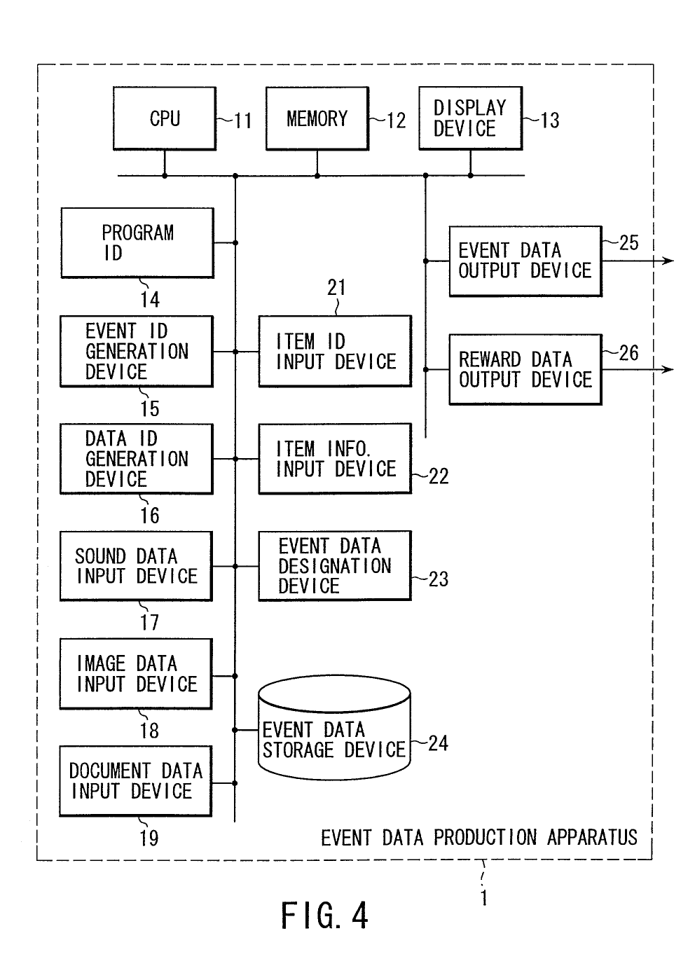

FIG. 4 is a diagram showing a functional block structure inside of the event data production apparatus 1.

The event data production apparatus 1 produces the event data based on the scenario which is considered by the scenario producer. Based on this produced event data, the event ID information and the event information are produced to constitute a set to be supplied to the program production apparatus 3 while producing the event ID information and the reward data to constitute a set to be supplied to the shop apparatuses 6.

A CPU 11 commands the control of the whole event data production apparatus 1. A memory 12 comprises a semiconductor memory device such as a DRAM or the like for temporarily storing data at the time of work such as compilation or the like while a display device 13 is intended to provide a display when the scenario producer conducts such work as compilation, content confirmation or the like.

A document data input device 19, an image data input device 18 and a sound data input device 17 are intended to input a message, icons, and effect sounds constituting advertisement. When each item of data such as these messages, icons and effect sounds is input, data is stored in the event data storage device 24 in a file format having as the file name the data ID produced by a data ID generation device 16 described later. For example, in the case where the data ID is 22, the message is stored in the event data storage device 24 with a file name 22. TXT, the icon is stored therein with a file name 22. BMP and the effect sound is stored therein with a file name 22. WAV.

A program ID input device 14 determines the program ID peculiar to the program for specifying the program for embedding the event information produced by the apparatus 1 and inputs the program ID therein. The program ID is determined by the scenario producer who provides information.

The event ID generation device 15 produces the event ID for specifying the event data. In the production of the event ID, for example, a random number sequence or the like may be used to produce numeric number data so that the produced data does not overlap the event ID of the produced event data and may be set as the event ID.

The program ID input by the program ID input device 14 and the event ID produced by the event ID generation device 15 constitute a set to be referred to as event ID information. This event ID information constitutes information for identifying the event data which is being produced from other event data.

The data ID generation device 16 generates data ID used as a name for specifying the message, the icon and the effect sound. The data ID may be produced in a method similar to the production method explained at the event ID generation device 15.

The item ID input device 21 is an ID for specifying the specific item out of many items present in the program.

The item information input device 22 inputs each kind of information (item information) comprising the image of the item, the name thereof, and an operation program. The item information is produced in such a manner that the item information is incorporated in the game program to be operated while the user executes the program.

The event data designation device 23 is used in the case where different event information is used as the reward data. A list of event data which is stored in the event data storage device 24 is displayed on the display device 13 while the scenario producer selects and specifies one of a plurality of event information which are displayed. Upon receipt of the event data from the scenario producer, the event data designation device 23 inputs the event ID information of the event data, namely, the program ID and the event ID.

The event data storage device 24 is a non-volatile memory device having a large capacity which stores many event information in accordance with the format of the event information having a variable length and which stores documents, images and sounds input in each kind of file format with the data ID as its file name.

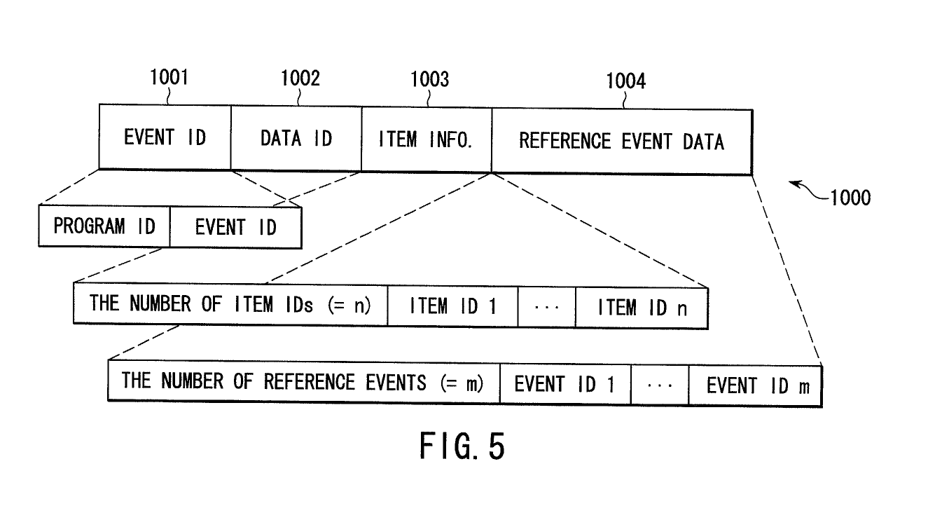

The event data format will be explained with reference to FIG. 5.

The event data comprises a storage area 1001 of the event ID information having a fixed length, a storage area 1002 of the data ID, a storage area 1003 of the item information having a variable length, and a storage area 1004 of the reference event information.

The storage area 1001 is an area for storing the program ID input by the program ID input device 14 and the event ID produced by the event ID generation device 15, and is used for the identification of the event data.

The storage area 1002 is an area for storing the data ID produced by the data ID input device 14, and is used for obtaining a plurality of files for conducting an event.

The storage area 1003 is an area for storing the number of the item IDs input in the event data and each item ID. The area for storing each item ID is present only in the number of the item IDs. For example, when no item ID is input in this event data, 0 is stored in the area for storing the number of the item IDs. No area is present for storing the item ID. In addition, for example, n item IDs are input in this event data, n is stored in the area for storing the number of the item IDs. Areas for storing the item ID are provided in the number of n while areas for storing the item ID are provided in the number of n so that item ID₁, item ID₂, . . . item IDₙ are stored. In this manner, the storage area 33 becomes a variable length area so as to correspond to the number of the item IDS.

The storage area 1004 is an area for storing the number of different event data linked to the present event data, and the linked event ID information (program ID and event ID). The areas for storing the linked event ID information are prevent in the number only equivalent to the number of items of the event ID information. This storage area 1004 also becomes a variable length area similar to the storage area 1003.

One item of event data is constituted as described above. Many items of event data constituted in this manner are stored in the event data storage device 24.

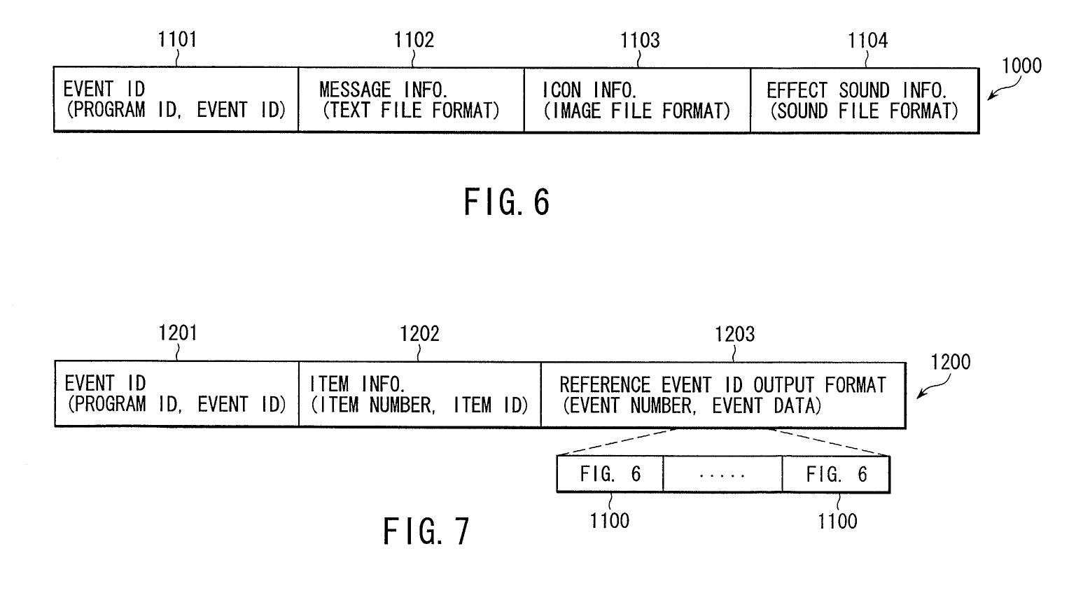

The event data output device 25 and the reward data output device 26 produce the event ID information and the event information shown in FIG. 6 based on the event data stored in the event data storage device 24 and output them to the program production apparatus 3. Furthermore, the event data output device 25 and the reward data output device 26 produce the event ID information and the reward data shown in FIG. 7 and output them to the shop apparatus 6.

The formats in FIGS. 6 and 7 will be explained. In FIG. 6, an area 1101 stores the program ID and the event ID which are event ID information. An area 1102 stores a document file designated with the data ID. The document file corresponds to the message in the advertisement. In an area 1103, an image file designated with the data ID is stored. The image file corresponds to an icon (ornament or the like) in the advertisement. In an area 1104, a sound file designated with the data ID is stored. The sound file corresponds to the effect sound in the advertisement.

On the other hand, in FIG. 7, in an area 1201, the program ID and the event ID which are event ID information are stored. In an area 1202, the number of items and the item ID for that portion are stored. In an area 1203, the number of events (=the number of event information items), and event information (=FIG. 6) corresponding to the event ID information of the link for that portion are stored.

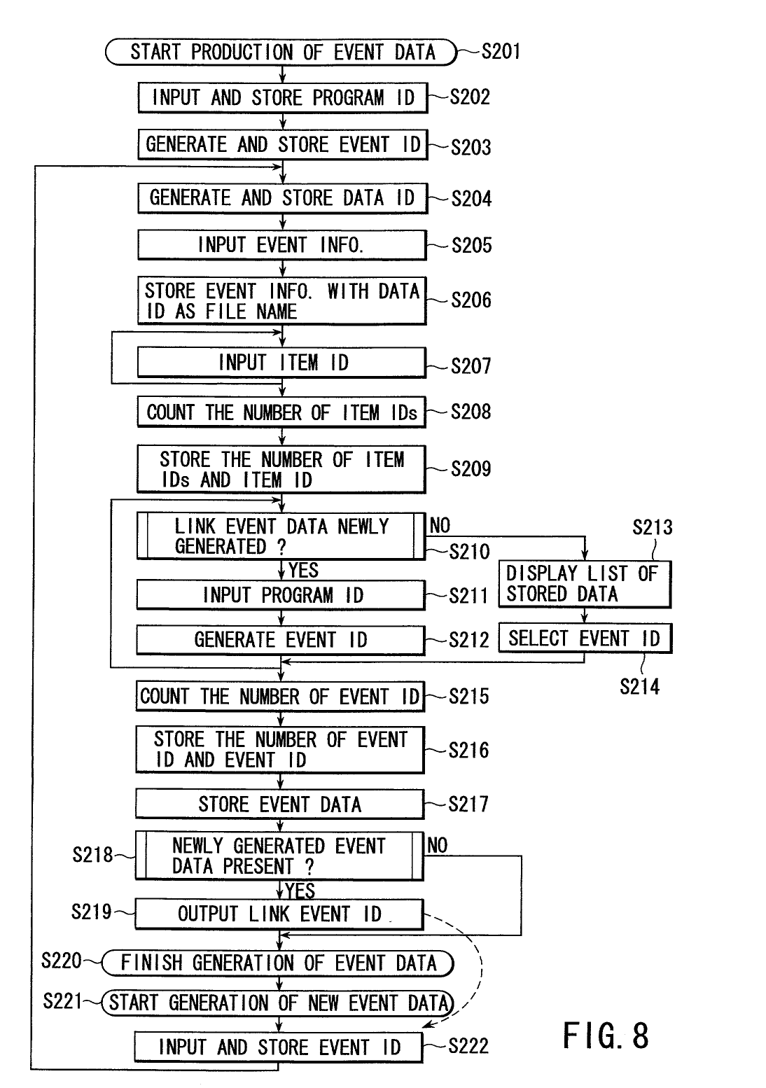

With respect to the event data production operation in the event data production apparatus 1 explained above will be explained by using the flowchart of FIG. 8.

The scenario producer starts up the event data production apparatus 1 and starts the production of the event data (S201). The scenario producer inputs the program ID of the produced event data with the program ID input device 14. The input program ID is temporarily stored in the work area of the memory 12 (S202).

The scenario producer instructs the production of the event ID with the event ID generation device 15 so that the event ID is generated and is temporarily stored in the work area of the memory 12 (S203).

The scenario producer instructs the production of the data ID with the data ID generation device 16 so that the data ID is produced and is temporarily stored in the work area of the memory 12 (S204).

The scenario producer inputs the event information (S205). The event information includes documents, icons and effect sounds for advertisement. The documents are input from a document data input device 19 in a predetermined file format. The icons are input from an image data input device 18 in a predetermined file format. The effects sounds are input from a sound data input device 17 in a predetermined file format.

Respective items of data of the input event information are stored in the event data storage device 24 by setting the data ID produced at step S204 as a name of the data (S206).

The scenario producer obtains the item ID of the item which is present in the game program and cannot be used and inputs the item ID (S207). The item ID is not necessarily required, or plural item IDs may be present. After the input of the item ID, the number of the input item IDs is counted (S208). Then, the number of the item IDs is temporarily stored in the work area of the memory 12 (S209).

The scenario producer determines in accordance with the scenario whether or not the event data (hereinafter, referred to as the link event data) following the event data which is being produced is to follow the present event data or the event data which is to be newly produced (S210).

As a consequence, in the case where the link event data is newly produced, it is required to determine the event ID information for specifying the link event data. Consequently, the scenario producer inputs the same program ID as the event data which is being produced to be temporarily stored in the work area of the memory 12 (S211). After that, in the method similar to the method of producing the event ID produced by the above step S203, the event ID is newly produced and is temporarily stored (S212).

On the other hand, at step S210, in the case where the link event data which is already produced is used, a list of the event data stored in the event data storage device 24 is displayed (S213). From this list, the scenario producer selects the link event data, obtains the selected link event ID information (program ID and event ID) and temporarily stores the information (S214).

The link event ID data is not necessarily required, and the item thereof may be present in plurality. Furthermore, after the input of the event ID information, the number of link event ID information which is input is counted (S215). Then, the number of link event ID information and link event ID information are temporarily stored in the work area of the memory 12 (S216).

As described above, the event data is constituted from data and information which are temporarily stored in the memory 12 and is stored in the event data storage device 24 (S217).

It is confirmed that the event data which is newly produced is present in the link event data (S218). In the presence of the event information which is newly produced, it is required to also produce the new event information, so that the event ID information of the link is output (S219) and finished.

In the presence of the event data which is newly produced, the production of the new event data is subsequently continued (S221). The event ID information output at step S219 is input and is temporarily stored in the work area of the memory 12 (S222). After that, through the processing similar to the processing after step S204, new event information is produced.

As described above, the event data production apparatus 1 produces the event data.

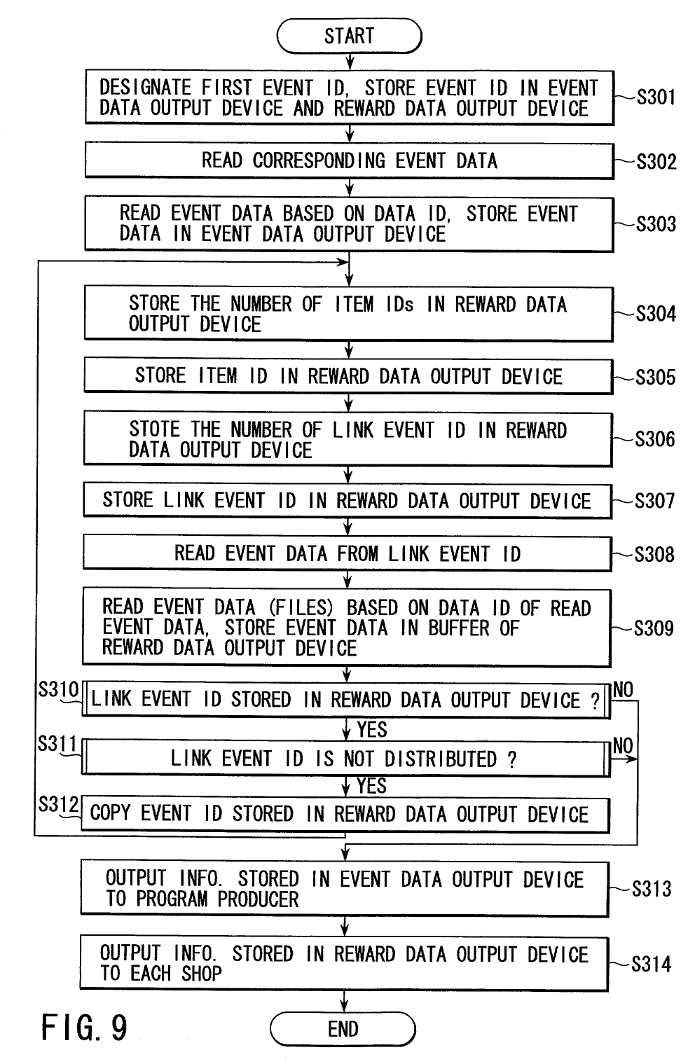

An operation of outputting the produced event data from the event data production apparatus 1 to the outside will be explained by using the flowchart of FIG. 9.

The scenario producer starts the output of the event data at the event data production apparatus 1. A buffer (not shown) is provided in the event data output device 25 and the reward data output device 26.

The scenario producer designates the first event ID information included at the beginning of the scenario. With this designation, the event ID information is stored in the buffer of the event data output device 25 and the buffer of the reward data output device (S301).

The event data corresponding to the event ID information is read from the event data storage device 24 (S302).

The data ID is obtained from the read event data, a group of files which coincides with the read data ID is read from the event data storage device 24 and the files are stored in the event data output device 25 (S303).

The number of the item IDS is obtained from the event data and stored in the reward data output device 26 (S304). Then, the item ID is obtained from the event data and stored in the reward data output device 26 (S305)

The number of the link event ID information is obtained and stored in the reward data output device 26 (S306). Then, the link event ID information is obtained and stored in the reward data output device 26 (S307) while the event information corresponding to the obtained link event ID information is read from the event data storage device 24 (S308). As described above, the event ID information of the link is not necessarily required.

A plurality of files for constituting advertisement are read from the event data storage device 24 based on the data ID of the event information read at step S308 so that the files are stored in the reward data output device 26 (S309).

At step S303, the event information is stored in the event data output device 25. However, there is a large difference in that the event information of the link event data is stored in the reward data output device 26. This is because the first event information (advertisement) is supplied from the program to be presented while the following event information (advertisement) is supplied from the shop as the reward data to be presented.

It is determined whether or not the link event ID information is stored in the reward data output device 26 (S310). In the case where the event ID information is stored, it is determined whether or not the link event ID information is newly produced and is not distributed to the shop (S311). In the case where the event ID information is not distributed, the event ID information stored in the reward data output device 26 is copied (S312). Then, the process returns to step S304 to continuously conduct an output operation of continuously outputting the non-distributed event data to the next shop.

On the other hand, in the case where the link event ID information is not stored (No at step S310), or in the case where the event ID information is stored, but the link event information is already distributed event information (No at step S311), it is not required to conduct an output processing of the event information any more, so that information stored in the event data output device 25 is output so as to supply the information stored in the event data output device 25 to the program producer (S313). Furthermore, the information stored in the reward data output device 26 is output to be supplied to the shop producer (S314).

In the event data production apparatus 1 which has been explained above, to enable the realization of the scenario, the first advertisement (event information) can be supplied to the program producer, and the second scenario and scenarios thereafter are supplied to the shop.

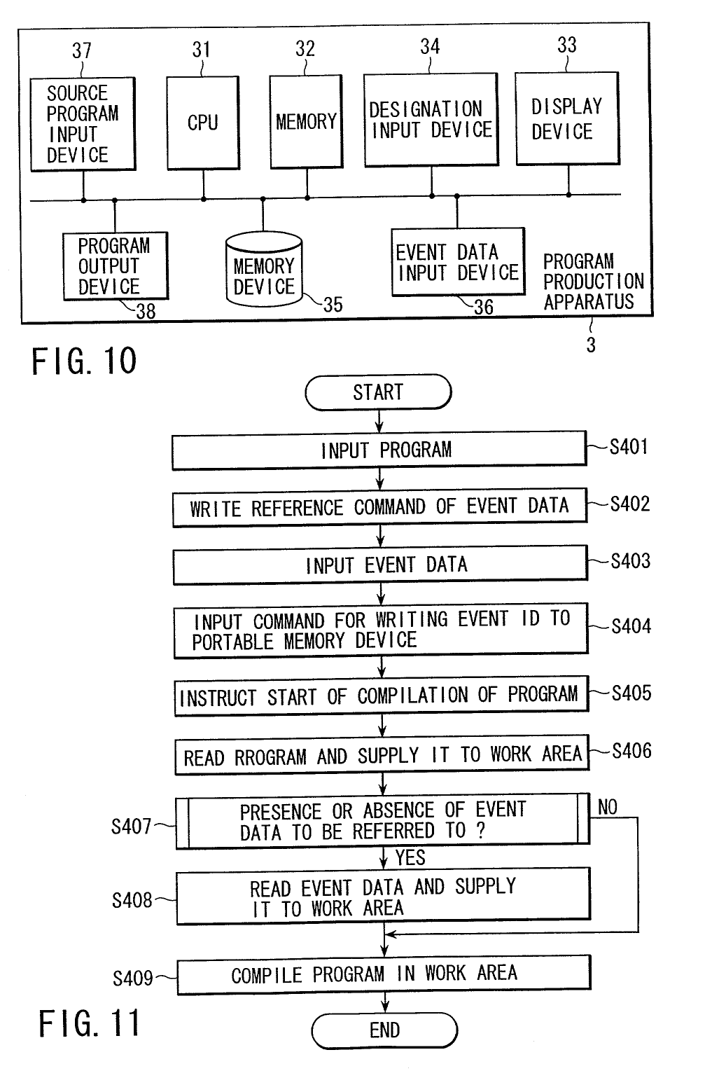

There will be explained the program production apparatus 3. FIG. 10 is a diagram showing a functional block structure of the program production apparatus 3. The program production apparatus 3 can be realized with a normal personal computer or the like.

The program production apparatus 3 comprises a CPU 31, a high-speed and volatile memory 32, a display device 33, an instruction input device 34 for inputting characters, and selecting data on the screen displayed on the display device 33 and a non-volatile memory device 35 having a large capacity constituted of a HDD or the like.

An event information input device 36 inputs event information produced and supplied by the event data production apparatus 1. A source program input device 37 inputs a source program produced by a program producer. The source program is also produced with the event data production apparatus so that the produced source program may be stored in the memory device 35. A game program output device 38 outputs a final program produced by embedding the input event information into the input source program.

There will be explained an operation in which a program provided to the user is produced with the program production apparatus 3. FIG. 11 shows an operation of the program production apparatus 3.

In the beginning, the program producer inputs a produced source program (S401). As the program, a story-like game program like a roll playing game or the like is desirable, but the program is not limited thereto. Furthermore, the explanation is limited only to the input of produced program. However, the program may be produced by using the apparatus 3.

The program producer determines the embedding position for embedding the event information received from the scenario producer, and writes an event information reference command at a position determined on the program (S402). For the sake of simplicity, the embedding position of the event information is determined by the program producer. However, in actuality, the embedding position of the event information is determined by the scenario producer. The program which is produced in this manner is stored in the memory device 35.

The event information is input from the event information input device 36 (S403). This input event information is stored in the memory device 35.

A command is input for giving an instruction of writing the event ID information to the portable memory device 5 (S404).

The program producer instructs a compilation of the program with respect to the program production apparatus 3 (S405). With this instruction, the program is read on the work area of the memory (S406). It is determined whether or not an event information reference command is present in the program (S407). In the presence of this command, the event information of the reference input at steps S403 and S404, the event ID information and a command for giving an instruction of writing these items of information in the portable memory device 5 are read to the work area (S408).

With a compilation of a program in the work area, an executable program is produced in which a command is embedded at a position of a reference command of the event information for giving an instruction of writing the event information of the reference, and the event ID information is written in the portable memory device 5 (S409).

As described above, the event information supplied from the scenario producer is inserted into the program.

The game producer distributes the executable program produced by a compiler to the user with a predetermined method. As a distribution method, the program may be stored in a CD, or a DVD-ROM to be distributed. The program may be distributed so that the program can be downloaded from the home page or the like.

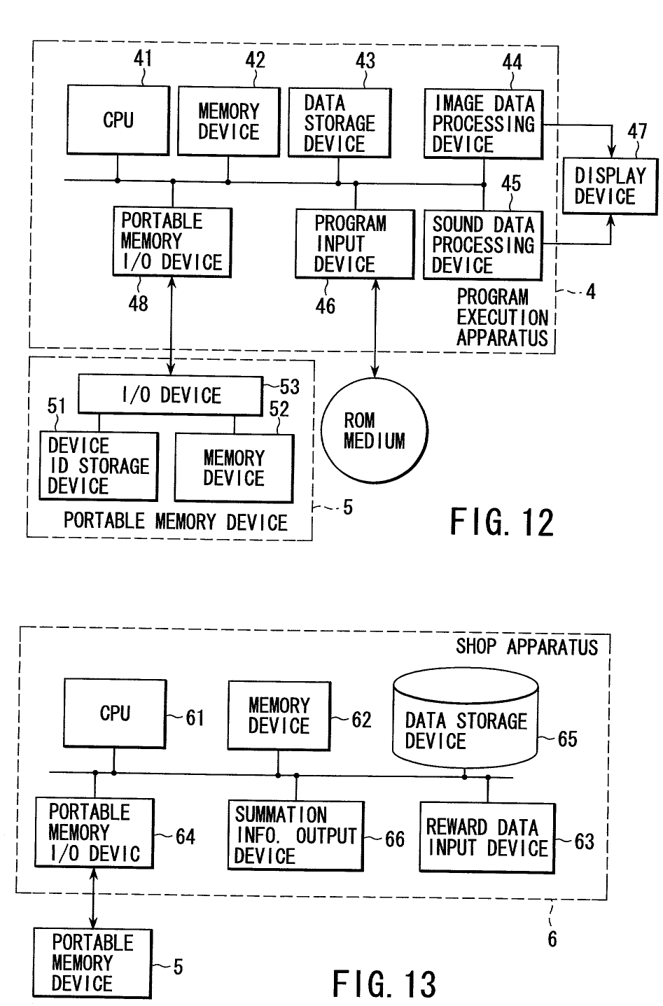

The program execution apparatus 4 will be explained. FIG. 12 is a diagram showing a functional block structure of the program execution apparatus 4 and the portable memory device 5.

The program execution apparatus 4 is provided with a CPU 41 for commanding the control of the whole apparatus, a volatile memory 42, a rewritable non-volatile data storage device 43, an image data processing device 44 for processing an output image of the program, a sound data processing device 45 for processing an output sound of the program, a program input device 46 for inputting a program stored in a ROM medium or the like, a display device 47 and an I/O device 48 of the portable memory device. The image data processing device 44 and the sound data processing device 45 are connected to the display device 47 such as the external display device, a TV device and the like.

Further, the program execution apparatus 4 is detachably connected to the portable memory device 5.

The portable memory device 5 comprises a device ID storage device 51 for storing a device ID of the portable memory device 5 itself, a rewritable non-volatile memory 52 and an I/O device 53 for controlling input and output of information.

There will be explained the shop apparatus 6. FIG. 13 is a diagram showing a functional block structure of the shop apparatus 6. Although the shop apparatus 6 can be realized with a normal computer system, a shop clerk is not required to directly input data to the shop apparatus 6. Consequently, an input apparatus such as a keyboard, a mouse or the like, and a display device or the like are not required.

The shop apparatus 6 includes a CPU 61 and a memory 62. Furthermore, the shop apparatus 6 is provided with a reward data input device 63 for inputting reward data shown in FIG. 7 which is output from the event data production apparatus 1. In the input of this reward data, the event data production apparatus 1 and the shop apparatus 6 are connected with a network for receiving the supply of data through communication. Otherwise, the reward data output at the event data production apparatus 1 is recorded on a recording medium or the like. This recording medium is read on the side of the shop apparatus 6 so that the input of the reward data may be received.

The input reward data may be stored in the data storage device 65.

Furthermore, the shop apparatus 6 is provided with a portable memory device I/O device 64 which can be connected with the portable memory device 5 which is possesses by the customers at the shop. Information on the customers who use the shop apparatus 6 (information on customers) is stored in the data storage device 65.

Furthermore, the shop apparatus 6 is provided with a summation information output device 66. This is intended to output information on the customers stored in the data storage device 65. The output customer information is stored in the recording medium and is supplied to the summation apparatus 7 by using the network.

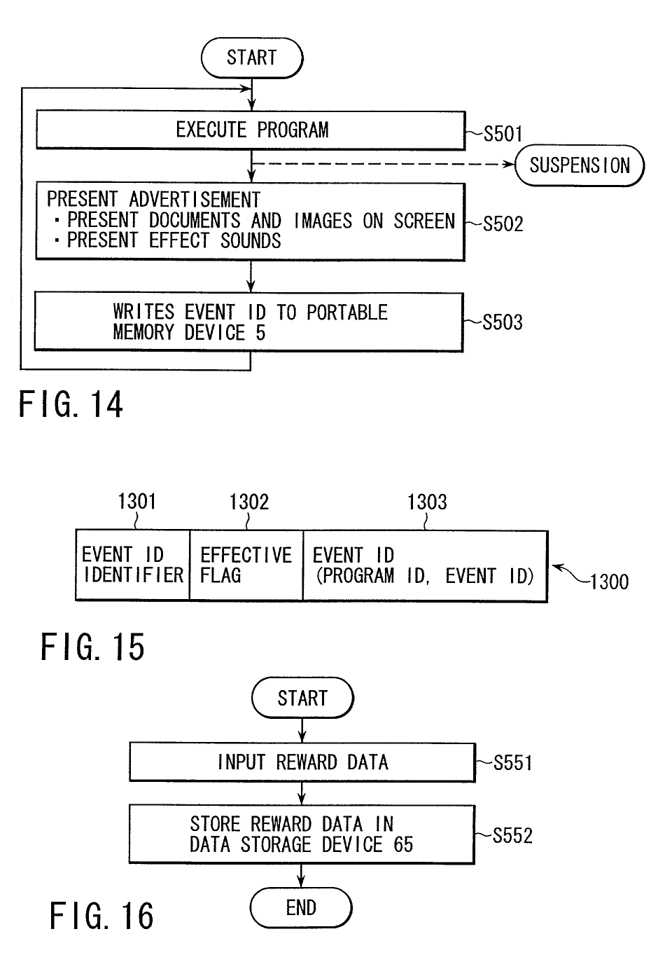

An operation of the program execution apparatus 4 and the shop apparatus 6 will be explained. FIG. 14 is a chart showing an operation at the time of the program execution in the program execution apparatus 4.

The user uses the program execution apparatus 4 to execute the program stored in the CD-ROM or downloaded from the Internet (S501).

When the program is executed to a predetermined part, the presentation of the event (advertisement) is received (S502). In the presentation of this advertisement, the documents and images are displayed on the screen and the effect sounds are generated.

Together with the presentation of the advertisement, the program execution apparatus 4 writes the event ID information of this event (advertisement) to the portable memory device 5 in the writing format 1300 shown in FIG. 15 (S503).

In FIG. 15, an event ID information identification area 1301 is an area for storing specific identification information (referred to as the event ID identifier) showing that the event ID information is written at step S503 at the program execution apparatus 4. An effective flag area 1302 is an area for storing a flag showing that this event ID information is effective or ineffective. When the event ID information is written at step S503, an effective flag is written without fail. Though explained in detail later, the event ID information is written on the supposition that the flag is ineffective. An event ID information area 1303 is an area for storing the program ID and the event ID.

After step S503, the user may suspend the program or may continue the program.

There will be explained an operation of storing reward data output from the event data production apparatus 1 by the shop apparatus 6 with reference to FIG. 16.

The reward data of the shop in the reward data output from the event data production apparatus 1 is input with the reward data input device 53 (S551).

This input reward data is stored in the data storage device 55 (S552).

As a consequence, the shop apparatus 6 can supply the reward data.

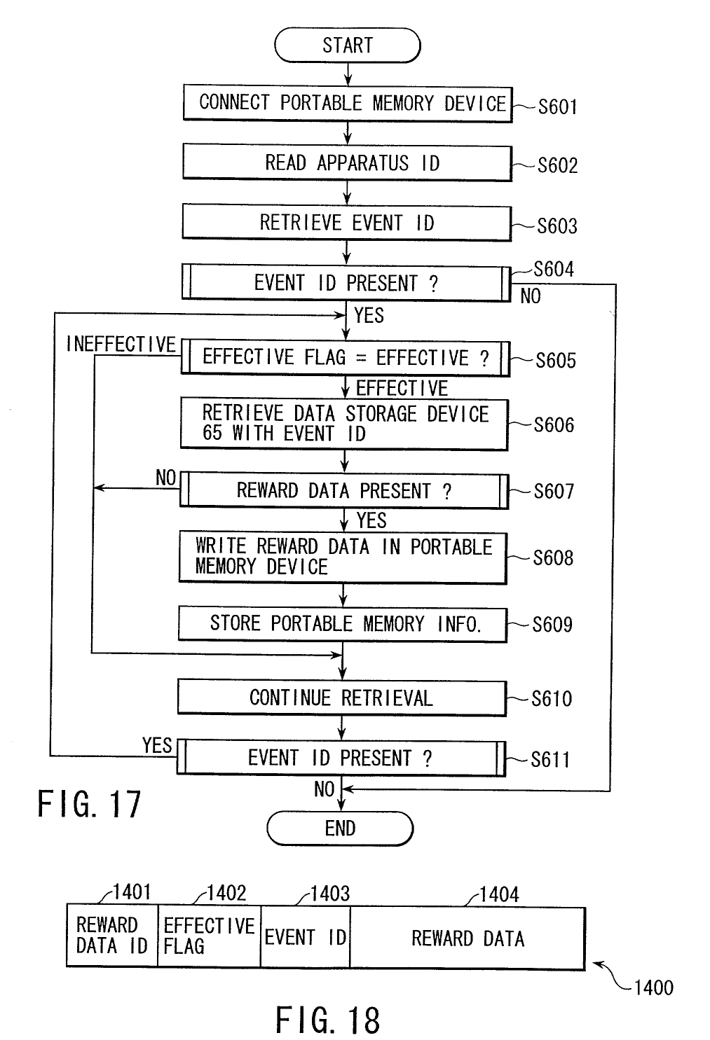

The procedure of supplying the reward data will be explained with reference to FIG. 17.

In the beginning, the user visits the shop and connects the portable memory device 5 which the user has carried to the portable memory I/O device 64 of the shop apparatus 6 (S601). The shop apparatus 6 reads the apparatus ID peculiar to the portable memory device 5 from the connected portable memory device 5 (S602).

The shop apparatus 6 retrieves the event ID identifier from the memory 52 of the portable memory device 5 (S603) to determine whether or not the event ID identifier is present (S604). In the case where the event ID identifier is present, it is determined whether or not the effective flag following the event ID identifier is effective (S605). When the flag is not effective, the next event ID identifier is retrieved (S610). On the other hand, when the flag is effective, the event ID information which is stored in the data storage device 65 in the shop apparatus 6 and coincides with the event ID information succeeding the flag is retrieved (S606). Thus, it is determined whether or not the event ID information which coincides with the stored event ID information, namely, the reward data according to the event ID information is present (S607). In the presence of the reward data, the reward data is written into the portable memory device 5 (S608). Then, the event ID information, the device ID obtained at step S602, the time and the like at that time are allowed to correspond to each other to be stored in the data storage device (S609). Then, this stored information is referred to as the portable memory device information. Then, subsequently, the retrieval of the next event ID identifier is continued (S610). On the other hand, when no reward data is present at step S607, it means that this event ID information does not belong to this shop apparatus 6, so that the retrieval of the next event ID identifier is subsequently continued (S610).

At step S610, the retrieval is continued to confirm the further presence or absence of the event ID identifier (S611). Then, in the case where the event ID identifier is detected, the process returns to step S605 to conduct a similar procedure after this. Furthermore, in the case where no event ID identifier is detected, the processing is completed.

At step S608, the writing format at the time of writing reward data to the portable memory device 5 will be explained with reference to FIG. 18.

In a format 1400, an area 1401 is an area for storing reward data ID information showing that the reward data is written with the shop apparatus 6. An area 1402 is an area for storing an effective flag showing whether or not the reward data of this format is effective. In this area 1402, a flag is written which shows the effectiveness when the flag is written by the shop apparatus 6, and a flag is written which shows the ineffectiveness when the reward data is used by the program execution apparatus 4. An area 1403 is an area for storing the event ID information. The area 1404 is an area for writing reward data read from the data storage device 65.

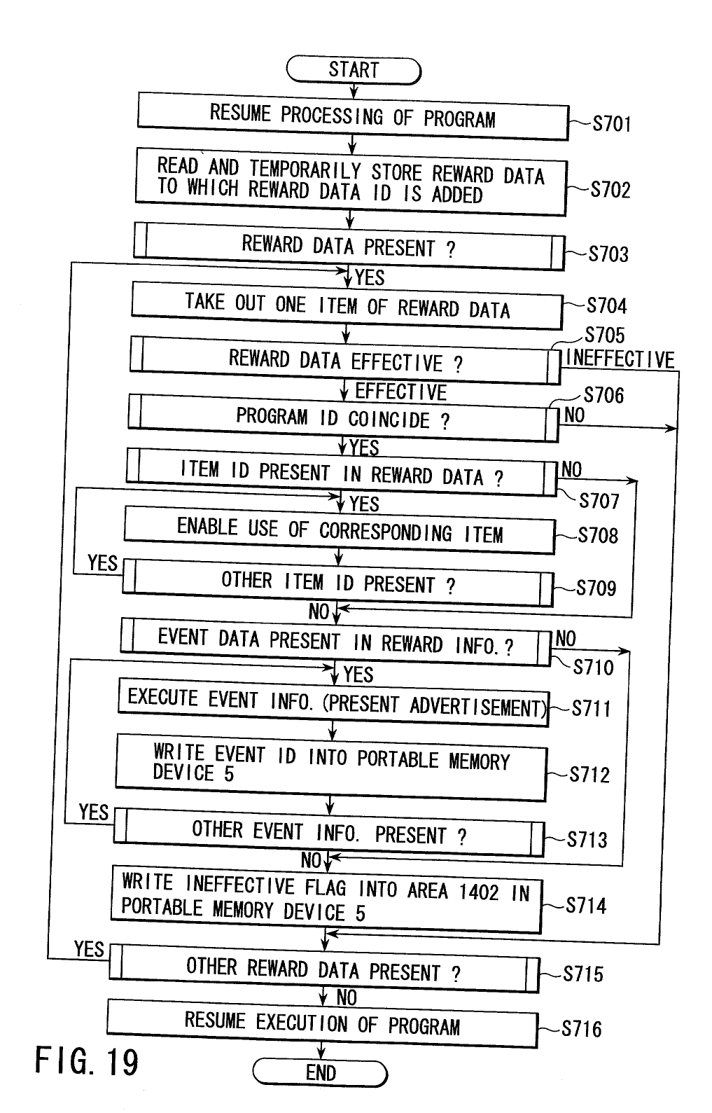

The user brings back the portable memory device 5 storing the reward data, connects the memory device 5 to the program execution apparatus 4 to resume the execution of the program. An operation at this time will be explained with reference to FIG. 19.

In the beginning, an instruction is given to resume the program so that the program resuming operation will be conducted (S701). In the resuming operation, an operation is conducted for writing data which is stacked at the time of the suspension to kinds of registers (not shown) inside of the program execution apparatus 4 so as to return to, for example, the suspension state of the program.

The program execution apparatus 4 detects the reward data ID information from the memory content of the portable memory device 5 and reads the reward data to temporarily store the content in the memory 42 of the program execution apparatus 4. The reward data has the format 1400 shown in FIG. 18. The presence or absence of the temporarily stored reward data is confirmed (S703) to resume the execution of the program without doing anything when the reward data is null (S716).

On the other hand, in the case where the temporarily stored reward data is present, one item of reward data is taken out (S704), and the effectiveness of the reward data is confirmed (S705). This is conducted by the determination on the flag of the area 1402. When the reward data is not effective, it is confirmed whether or not the other reward data is present in the memory 42 supposing that the reward data is unavailable data (S715).

On the other hand, in the case where the reward data is effective, it is determined whether the program ID of the event ID information next stored in the area 1403 coincides with the program ID of the program. As a consequence, when the two do not agree with each other, it is confirmed whether or not other reward data is present in the memory 42 supposing that the reward data is data which cannot be used in the program (S715).

On the other hand, when the program IDs coincide with each other, it means that the reward data can be used in the program to obtain the reward data of the area 1404 at the following step.

It is determined whether or not the item ID is present in the reward data (S707). In the presence of the item ID, processing is conducted on the program so that the item shown by the item ID can be used (S708). This processing controls the current item list holding the item IDs showing the currently usable items, and the list can be realized by adding the item ID which can be used at this time to the current item list. The control of the item in the program depends on a method of producing the program, and is not limited to this example.

It is determined whether or not other item IDs are present (S709). When other item IDs are present, in the same manner as step S708, processing is conducted on the program so that the item shown by the item ID can be used. In this manner, all the item IDs included in the reward data can be used on the program.

It is determined whether or not the event information is included in the reward data of the memory 32 (S710). When the event information is included, the event information is conducted (S711). As a consequence, a new advertisement is provided to the user. Then, the event ID information of the event information is written in the portable memory device 5 (S712).

It is determined whether or not the other event information is present in the reward data (S713). In the presence of the other event information, the event information is conducted in a similar manner as steps S711 and S712 to write the event ID information of the event information to the portable memory device 5. In this manner, all the event information included in the reward data is conducted to be written into the portable memory device 5.

Since this reward data is already used, a flag showing ineffectiveness is written to the area showing the effective flag of the reward data of the portable memory device 5 (S714). This is intended to prevent the disadvantage of the shop as a result of the fact that the reward data is used by a plurality of people.

It is determined whether or not the other reward data is temporarily stored in the memory 42 in the program execution apparatus 4 (S715). When the data is temporarily stored, the process returns to the processing at step S704 and steps thereafter again.

In this manner, when the confirmation of all the reward data which are temporarily stored is completed, the resumption of the program execution is started (S715).

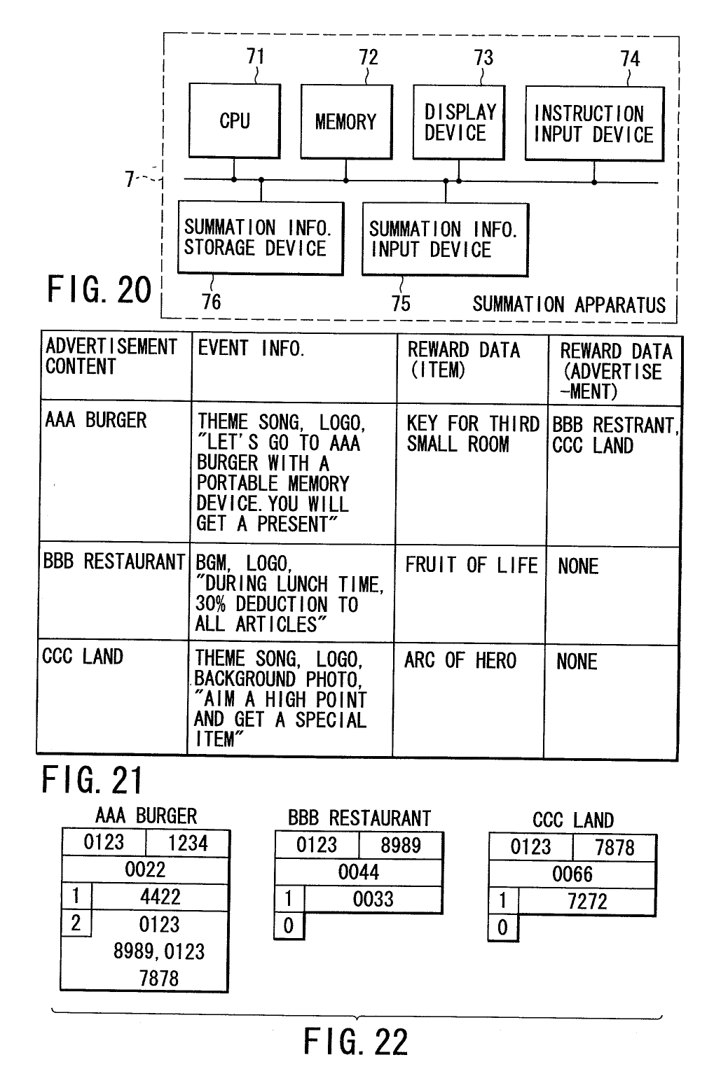

FIG. 20 is a diagram showing a function block of the summation apparatus 7. The apparatus 7 will be explained hereinbelow.

The summation apparatus 7 comprises a CPU 71 for commanding the control of the whole summation apparatus 7, a volatile memory 72, a display device 73 and an instruction input device 74 such as a keyboard, a mouse or the like. Furthermore, the summation apparatus 7 comprises a summation information input device 75 for inputting customer information output from each of the shop apparatuses 6, and summation information storage device 76 for storing the input customer information.

The summation apparatus 7 processes and sums the customer information stored in the summation information storage device 76 under the control of the program by using the CPU 71, and a result thereof is displayed on the display device 73.

As a display instruction, it is possible to designate, for example, the following summation method as a summation data display instruction.

1. A method of summing up every apparatus ID: for citing the event ID of each portable memory device 5 or counting the total number thereof.

2. A method of summing up every event ID information (or the program ID): there are provided the following three methods:

a) to cite the apparatus ID of the portable memory device 5 in which the event ID of the characteristic is registered or count the total number thereof;

b) to cite the apparatus ID of the portable memory device 5 in which the designated event ID is practiced in order, or count the total number thereof; and

c) to cite the apparatus ID of the portable memory device 5 in which all the event IDs are practiced or count the total number thereof.

3. A method of summing up for each resolution time: the following two methods are given:

a) to cite the apparatus ID of the portable memory device 5 in which a specific event ID is registered or to count the total number thereof in the designated period; and

b) to cite the apparatus ID of the portable memory device 5 in which any of the event ID is registered or count the total number thereof in the designated period.

The above description describes one example of the summation method, and other summation methods may be used.

As described above, a system according to the first embodiment of the present invention has been explained. One concrete example using this system will be explained hereinbelow.

It is supposed that the program producer intends to prepare a role playing game program under the title of the Legend of XYZ. It is also supposed that the scenario producer has a contact with the program producer to receive a detailed explanation of the Legend of XYZ and have a confidence that the program will sell well. Then, suppose that the scenario producer wants to have a consultation with the program producer to the effect that advertisement presentation function is contained in the Legend of XYZ and establish a contract between them.

Next, the scenario producer raises shops which desire the presentation of advertisement in the Legend of XYZ. As a consequence, a hamburger shop AAA burger, an Italian restaurant BBB restaurant, an amusement park CCC land obtain a right of the presentation of advertisement in the Legend of XYZ. The scenario producer individually makes a contract with the AAA burger, BBB restaurant, and CCC land, respectively. In the contract of advertisement in the Legend of XYZ, the first priority right advertiser is the AAA burger, the second priority right advertiser is the BBB restaurant. In a similar manner, the third priority contractor concludes a contract in the same condition content formed with the CCC land.

After such presupposition condition is set up, the scenario producer prepares the advertisement scenario this time based on each of the contracts. Here, the scenario producer prepares the following scenario based on, for example, each of the above contracts.

### Scenario/Start

During the play of the Legend of XYZ, when a hero open a treasure box in donjon, he finds a drink (S size) service ticket in the box. When this ticket is obtained, a theme song of the AAA burger is reproduced. Together with the logo of the AAA burger, on a game screen, a message is displayed which goes as follows: “Let's go to AAA burger with a portable memory device. You'll get some present. You'll also get a drink (S size) free of charge (advertisement of the AAA burger).”

Then, when visiting an AAA burger shop, a game item a key for a Third Small Room, advertisement of the BBB restaurant, and advertisement of the CCC land are supplied. It is expected for the AAA burger that the user purchases a hamburger when the user visits and get a free drink.

When the user brings back the supplied item and advertisement stored in the portable memory device 5, and resumes the game, the BGM of the BBB restaurant is reproduced in the same manner as the AAA burger. Together with the logo of the BBB restaurant, a message is displayed which goes as follows “during lunch time, 30% deduction to all products (advertisement of the BBB restaurant).” After a predetermined period of time, a theme song of the CCC land is reproduced in the same manner. Together with the logo of the CCC land and a background photo of a Cyber Shoot which is one of the attractions of the CCC land, a message is displayed which goes as follows “aim a high point and get a special item (advertisement of the CCC land).” When the user visits a shop of the BBB restaurant, the game item Fruit of Life is supplied. Furthermore, when the user visits the Cyber Shoot which is one of the attractions in the CCC land and gets a high point, the game item Arc of Hero is supplied.

### Scenario/Finish

The hero who appears in the scenario means the hero who appears in the game of the Legend of XYZ. The game item means an item such as a useful item in the proceeding of the game used in the game.

When the above scenario is put in order with the event information and the reward data, a table shown in FIG. 21 is provided. In the table, the first row shows information for the first event information, the second row shows information for the second event data, and the third row shows information for the third event. As reward at the AAA burger, free service of a drink (S size) is provided. However, this is not a service supplied on this system but is directly given to the user by the shop. This is not included in the reward data on this system.

Next, the scenario producer prepares event data by using the event data production apparatus 1 based on the produced scenario. The procedure for producing the event data by the scenario producer in this scenario will be carried out in the following manner.

1) Input of the program ID “0123” of the Legend of XYZ.

In the case where the program producer regulates this ID, the event producer asks the program producer. In the case of where the event producer regulates this ID, he or she determines and input the ID. Here, the program ID is set to “0123.”

2) Produce instruction of the event ID of the AAA burger which is the first event (first row in FIG. 21).

Here, the produced event ID is set to “1234.”

Hereinafter, the production of the event ID information is completed with the above 1) and 2).

3) Production instruction of the data ID of the first event.

Here, the produced ID is set to “0022.”

4) Input of the theme song of the AAA burger.

This input is already produced in an audio file (AVI) format. The electronic data file may be read. An analog sound (raw sound) which is not yet formed in a file format is input and is converted into an audio file format to be formed into an electronic data file to be stored.

5) Input of the logo of the AAA burger.

In this input, an image file of the logo produced in advance may be input. Furthermore, the photo of the logo may be scanned with a scanner to be digitalized to be input. The image file may be newly produced and input in applications for image compilation. For the simplification of the explanation, only the logo may be input. Map information showing a shop and various items of pop art for the beautification of the advertisement screen may be input.

6) Input of advertisement sentence of the AAA burger “Let's go to AAA burger with a portable memory device. You'll get some present.”

In this input as well, the document file which is produced in advance may be input. Furthermore, the file may be newly produced in the application for the input of the document.

The name of each file input in steps 4) to 6) is changed to the data ID produced by step 3) and is stored in the event data storage device 24.

7) Input of the item ID of the key for the Third Small Room.

This item ID is obtained from the program producer. Here, the item ID is set to “4422.”

When the input of the item ID is completed, the number of the input item ID is automatically counted. In this case, the number becomes 1.

8) Select new production as an input method of the event of the link.

The link events are the BBB restaurant and the CCC land. Both are produced in the new production. Because of this, the new production has been selected. As an input method, it is possible to select the usage of pre-existent event information. For example, in the case where the event of the BBB restaurant is already produced in the different game program, the usage of the pre-existent event information is selected so as to link to the event. Generally, a condition which enables the selection of the usage of the pre-existent event information is a case in which the designation of the item is not included in the reward data of the event. That is because the item ID is peculiar to each of the programs. Consequently, in the case where the item ID of the different program is used, an operation error is caused.

9) Input of the program ID “0123” of the Legend of XYZ.

Here, the program ID is input by the event producer, but may be automatically input from step 1).

10) Production instruction of the event ID of the BBB restaurant which is the link event (second row of FIG. 21).

Here, the event ID of the BBB restaurant ID is set to “8989.”

11) Input of the program ID “8989” of the Legend of XYZ.

12) Creation instruction of the event ID of the CCC land which is the event of the link (third row of FIG. 21).

Here, the event ID of the CCC land is set to “7878.”

The advertisement provided as reward data in the event of the AAA burger are the BBB restaurant and the CCC land, these shops are identified in steps 9) to 12). At this point, the actual event information of the BBB restaurant and the CCC land does not exist yet. When the processing of steps 9) to 12) are finished, the number of the event of the link is automatically counted. In this case, the number becomes 2.

As described above, steps 1) to 12) are conducted by the event producer, and the event production of the AAA burger is finished.

By the way, since the event information of the BBB restaurant and the CCC land which are links of the event of the AAA burger does not yet exist in this state, these items of the event information must be subsequently produced.

Then, the production of the event information of the BBB restaurant is started.

13) Automatic input of the program ID and the event ID of the BBB restaurant.

Since the operation is continuously conducted, the program ID and the event ID input and produced by steps 9) and 10) are automatically input with the input and produced program ID “0123” and the event ID “8989.”

14) Production instruction of the data ID.

Here, the data ID is set to “0044”.

15) Input of the BGM used at the BBB restaurant.

16) Input of the logo of the BBB restaurant.

17) Input of advertisement sentence of the BBB restaurant “during lunch time, 30% deduction to all products.”

The name of each file input at steps 14) to 16) is changed to the data ID “0044” produced by step 13) to be stored in the event data storage device 24.

18) Input of the item ID Fruit of Life.

When the input of the item ID is finished, the number of the input item ID is automatically counted. In this case as well, the number becomes 1. Here, the item ID is set to “0033.”

19) Select no input of the event of the link.

On the scenario, no link is made from an event of the BBB restaurant to a different event. Consequently, none is selected.

In the procedure of steps 13) to 19), the event information of the BBB restaurant is produced.

After this, subsequently, in the same manner as the procedure of the production of the event information of the BBB restaurant, the event information of the CCC land is produced. Here, the data ID of the event information of the CCC land is set to “0066” and the item ID of the item Arc of Hero is set to “7272.”

In the above manner, three items of event information, namely, AAA burger, BBB restaurant, and CCC land events are produced. FIG. 22 is a diagram showing these produced three items of event information.

Next, the event producer conducts the output processing of these items of produced event information.

The event producer designates the program ID and the event ID of the AAA burger which is the first event to provide an output instruction. The event data production apparatus 1 receives this instruction. The event data production apparatus 1 receives this instruction to read the event of the AAA burger from the event data storage device. The event is separated into the event information and the reward data to be output. Furthermore, with respect to the BBB restaurant and the CCC land which are linked as the reward data of the event of the AAA burger, the event information is not output and only the reward data is automatically output. This is because the advertisement supplied from the program is only the first advertisement, and the advertisement linked thereafter is given as reward.

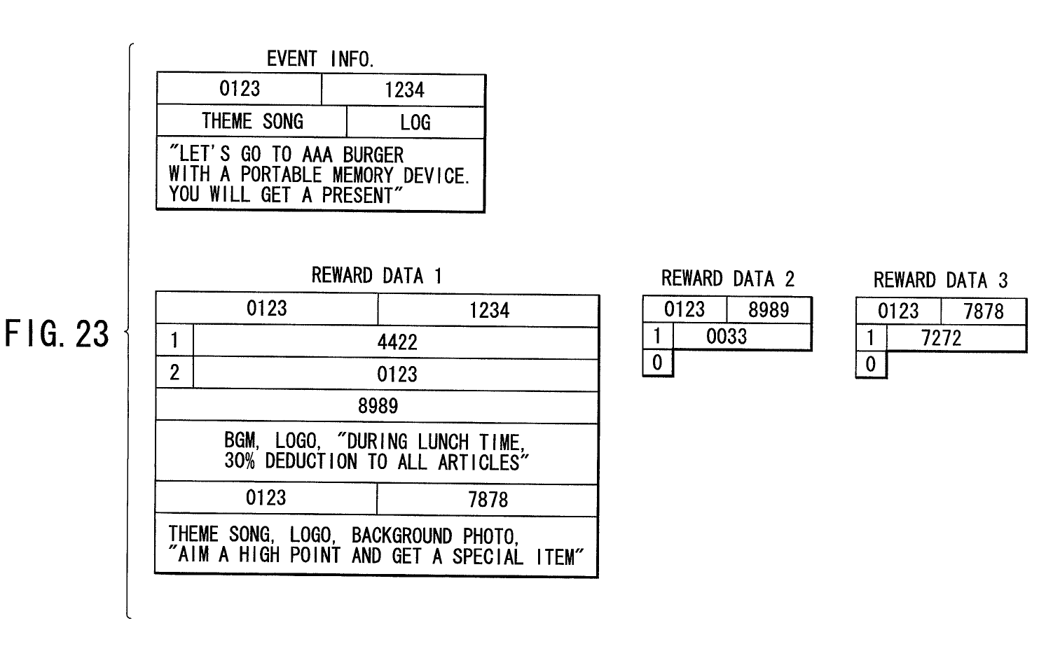

FIG. 23 is a diagram showing event information and reward data which are output. As shown in FIG. 23, one item of event information is output and three items of reward data are output. In FIG. 23, the event information is received by the program producer. The reward data 1 is received by the shop of the AAA burger. The reward data 2 is received by the shop of the BBB restaurant. The reward data 3 is received by the shop of the CCC land.

The program producer prepares the game program of the Legend of XYZ. In this game program, an item operation which works in a favorable manner during the progress of the program is described in subroutines. The program is produced in such a manner that the user constantly jumps to the subroutine of the item and can use the items when the program is registered on an item list for controlling the items. In this specific embodiment, operation programs such as a key for Third Small Room, Fruit of Life, and Arc of Hero are included as a subroutine.

Furthermore, the program producer embeds the event information in a predetermined position on the progress of the program so that the event information received from the event producer is started up.

Then, the Legend of XYZ which is produced in this manner is converted into an executable program format which can be executed with the program execution apparatus 4 to be written on a CD-ROM or the like to be sold.

On the other hand, three items of the reward data are supplied to respective shops. Each of the shops stores the supplied reward data in each of the shop apparatuses.

The user who purchased the Legend of XYZ executes the Legend of XYZ with the program execution apparatus 4. Here, it is supposed that program execution apparatus 4 is attached with the portable memory device 5. During the play of the Legend of XYZ, when the hero opens a treasure box in the donjon, he finds a drink (S size) service ticket. When he obtains the ticket, the embedded event information is obtained. That is, the theme song of the AAA burger is reproduced. Together with the logo of the AAA burger, a message is displayed on the game screen which goes as follows “Let's go to the AAA burger with a portable memory device. You will get some present. You'll also get a drink service free of charge (advertisement of the AAA burger).” At the same time, the event ID information “0123, 1234” of this event is written on the portable memory device 5. In the case where the portable memory device 5 is not attached on the program execution apparatus 4, a message may be provided please attach the portable memory device 5.

After the advertisement is finished, the user may immediately suspend the game or may continue the game at this point.

The user carries this portable memory device 5 and visits the shop of the AAA burger. Then, this portable memory device 5 is inserted into the shop apparatus 6 provided on the shop the user visits.

In the shop apparatus 6 of the AAA burger, the reward data 1 of FIG. 23 is stored. The shop apparatus 6 reads the apparatus ID of the portable memory device 5. The apparatus 6 reads data stored in the portable memory device 5. The read data is “0123, 1234” and coincides with the event ID information of the reward data 1 stored in the shop apparatus 6, so that the reward data 1 is written into the portable memory device 5. When the information is added, the event ID information overlaps. Thus, the information is overwritten. The apparatus ID is stored in the shop apparatus 6.

After the reward data is written into the portable memory device 5 at the shop of the AAA burger and the user returns his or her home, the user connects the portable memory device 5 to the program execution apparatus 4, and resume the game.

The program execution apparatus 4 reads data stored in the memory of the portable memory device 5. After it is confirmed that the reward data is included, the memory content of the portable memory device 5 is erased. In the beginning, the item ID “4422” is read from the read data and additionally registered in the item ID list. As a consequence, the key for the Third Small Room corresponding to the subsequent items ID “4422” can be used at all times. Here, since the Legend of XYZ is supplied with the CD-ROM, the item ID list is stored in the data storage device 43 in the program execution apparatus 6 and this item ID list is realized by allowing peculiar identification number to the Legend of XYZ.

Next, each file constituting an event from the read data is taken out to be reproduced. In this example, two events are present so that the first BGM, first logo, and “during lunch time, 30% deduction to all the products” are taken out with the result that the advertisement of the BBB restaurant is reproduced. At the same time, the event ID information “0123, 8989” is written into the memory of the portable memory device 5. Then, the second theme song, logo and background photo, and “aim a high point and get a special item!” are taken out and advertisement of the CCC land is reproduced. At the same time, the event ID information “0123, 7878” is written into the memory of the portable memory device 5.

After this, the game is resumed. Incidentally, after resuming the game, the key for the Third Small Room can be used.

The user can visit the BBB restaurant and the CCC land from the reproduced advertisements carrying the portable memory device 5. In the same procedure as described above, the reward data 2 and the reward data 3 are stored in the portable memory device 5. The portable memory device 5 is connected to the program execution apparatus 5 and the Legend of XYZ is started up to be resumed, the item IDs “0033” and “7272” are added and registered so that the IDs can be used later. Furthermore, since no event is put into the reward data 2 and 3, no advertisement is provided. Consequently, the scenario is finished at this point.

By the way, the apparatus ID stored in each shop apparatus 6 is output, for example, every one week, and is supplied to the summation apparatus 3. The summation apparatus 3 can sum up the person who visits the first shop attracted by the present advertisement method. An analysis of the summation result constitutes a good material for investigating the validity of the unit price of the advertisement.

As has been explained above, in the first embodiment, the first advertisement is inserted into the program to be used by the user, the advertisement is forcibly presented with the progress of the program with the result that an exposure effect of the advertisement to the user will be excellent. Since the advertisement is one of the shop where the user can obtain reward data, it has an effect of guiding the user to the shop. Further, in the case where the event information for presenting the advertisement to the next shop is included in the reward data obtained by the user with shop visit, it is possible to guide the user to the next shop. Then additional pleasure such as a rally game or the like is provided apart from the program. There is provided a synergetic effect advantage in that this leads to the expansion of the program sales, and a capacity of attracting customers will be raised. Consequently, the value of the advertisement provided by the system will be increased as well.

Furthermore, it becomes possible to measure the access situation by the advertisement, namely the guiding effect of the advertisement because information on the portable memory device is obtained while giving the reward data.

It can be explained that the reward data for each of the shops is individually supplied from the event data production apparatus 1 to each of the shop apparatuses 6 in the embodiment. For example, the reward data for each of the shops which information may be produced by the event data production apparatus 1 is stored in the CD-ROM in a package so that information is distributed to each shop. However, in this case, it is desirable that only the reward data for each shop can be output at each shop. As a consequence, a correspondence relation between each of the reward data and the usable shop apparatus is stored in the CD-ROM as the table, so that this table is referred to at each shop apparatus 6 and only necessary information is stored in the apparatus. Furthermore, the CD-ROM itself is regarded as a data storage device of the reward data of the shop apparatus. The table is confirmed at the time of supplying the reward data, and the reward data that can be supplied may be limited.

Other embodiments of the advertisement system according to the present invention will be described. The same portions as those of the first embodiment will be indicated in the same reference numerals and their detailed description will be omitted.

### Second Embodiment

In the first embodiment, when the event data is once output, the reward data supplied to the advertisement (event) cannot be changed. In the second embodiment, after the event data is output, the reward data supplied to the advertisement can be changed.

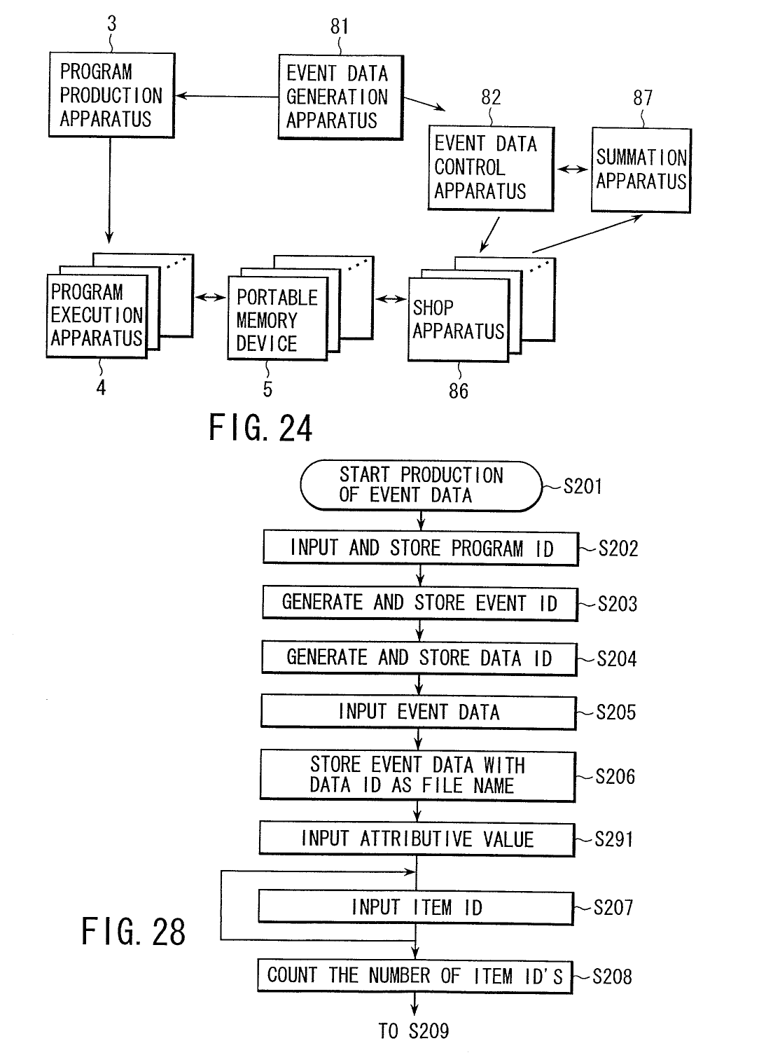

FIG. 24 is a diagram showing the whole system according to the second embodiment.

An event data production apparatus 81 prepares the event data based on the scenario which is planned by the scenario producer. Based on the produced event data, the event data and the reward data including the event ID information are output.

An event control apparatus 82 stores the reward data output from the event data production apparatus 81 while the reward data to be supplied can be controlled when the information of the portable memory device 5 is input from a shop apparatus 86 with the event control data input by the scenario producer at the event control apparatus 82. The information of the portable memory device 5 refers to the apparatus ID and the memory content here.

The shop apparatus 86 is installed at the shop which is advertised in the event information and connected to the event control apparatus 82 with the network. Furthermore, the shop apparatus 86 can be connected to the detachable portable memory device 5. When the portable memory device 5 is connected to the shop apparatus 86, the information of the portable memory device 5 is read and is supplied to the event control apparatus 82. As a consequence, the reward data output from the event control apparatus 82 is supplied to the portable memory device 5.

The summation apparatus 87 stores an output of the information associated with the portable memory device 5 stored in the shop apparatus 86. The summation apparatus 87 sums under the instruction of the event control apparatus 82 and the result is supplied to the event control apparatus 82.

The program production apparatus 3, program execution apparatus 4, and portable memory device 5 have the same structure as the first embodiment and conduct the same operation. Consequently, in the following explanation, the structure of each of the apparatuses will be explained. However, an explanation of the program production apparatus 3, program execution apparatus 4 and portable memory device 5 will be omitted.

In the event data production apparatus 81, shop apparatus 86 and summation apparatus 87, the same structure and the operation as the first embodiment are present in large numbers. Consequently, in the following explanation, the same structure and the operation as the first embodiment are denoted by the same reference numerals, and an explanation thereof is omitted.

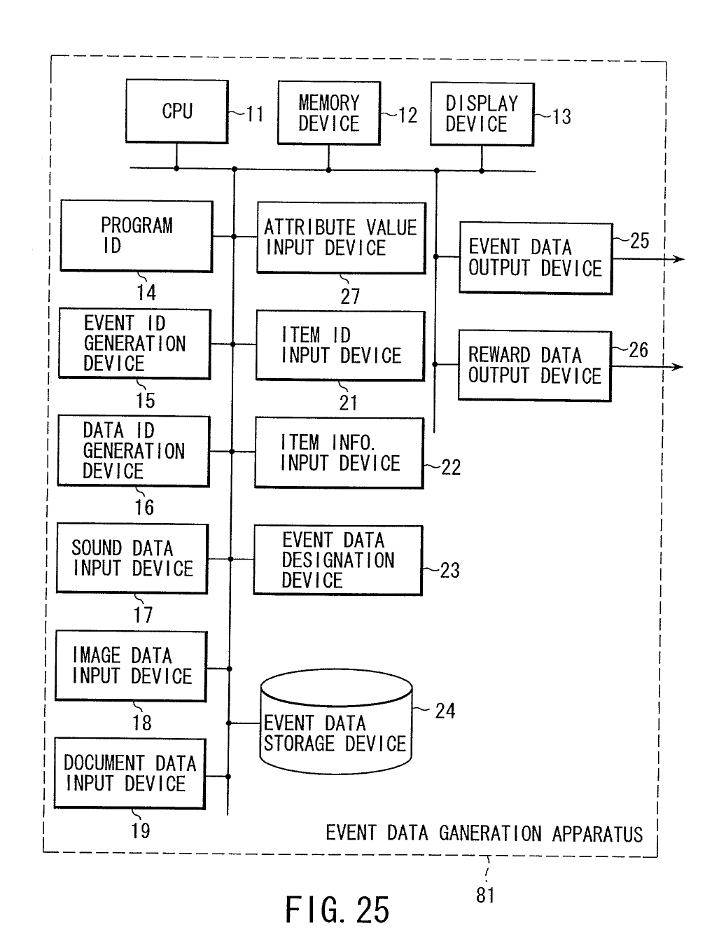

FIG. 25 is a diagram showing a functional block structure inside the event production device 81. An attribute value input device 27 gives an attribute value to the reward data of the event data.

In this embodiment, two kinds of values such as an advantage grade and a service grade are given as attribute value. The advantage grade here refers to a degree of the effect given when all the items supplied in this reward data are used in this program (program executed by the user who uses this reward data) with, for example, three grades. The service grade here refers to the evaluation of the value of the whole event (next advertisement) supplied in this reward data in three grades. These attribute values are determined and input by the scenario producer who provides information.

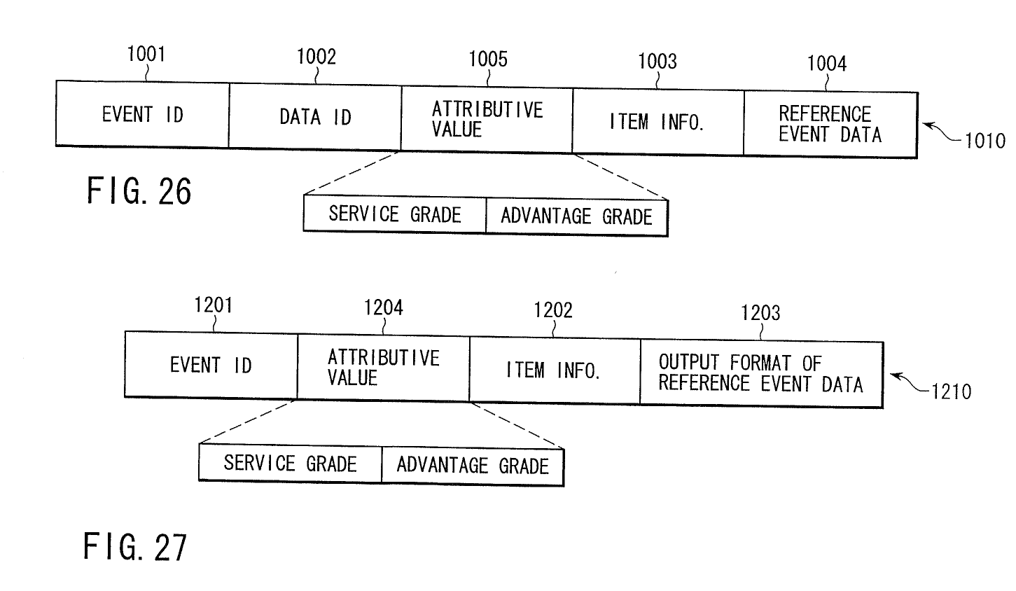

The format of the event data produced by this event data production apparatus 81 is shown in FIG. 26. In this format 1010, an area 1005 showing an attribute value is additionally provided between the data ID 1002 and the item information 1003 of the event data format of the first embodiment. In the area 1005 of this attribute value, a service grade and an advantage grade are stored.

The format of the reward data at the time of outputting the event information produced by the event data production apparatus 81 is shown in FIG. 27. In this format 1210, an area 1204 for storing the attribute value is additionally provided between an area 1201 for storing the event ID information of the first embodiment and an area 1202 for storing the item information. In the area 1204 for storing this attribute value, the service grade and the advantage grade are stored.

The format of the event information at the time of outputting the event information produced by the event data production apparatus 81 is the same as the first embodiment.

An operation flow of the production of the event information will be explained with reference to FIG. 28.

In the operation flow of the event information production, after steps S201 through S206 explained in FIG. 8 of the first embodiment are practiced, the step in which the scenario producer inputs an attribute value (S291) is additionally practiced. Here, the input attribute values are provided in two kinds; the service grade and the advantage grade.

Then, after this step S291, step S207 and steps thereafter of FIG. 8 are conducted to produce the event data.

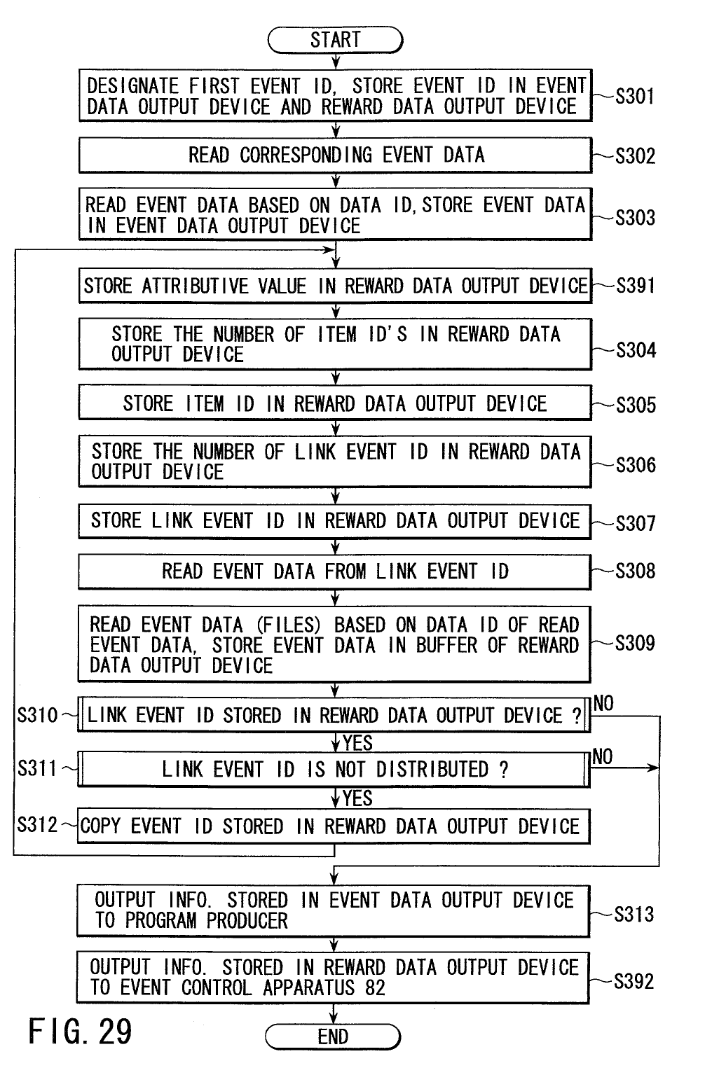

An operation flow of the event data output will be explained with reference to FIG. 29.

After the steps S301 through S303 are executed explained in FIG. 9 of the first embodiment, or after the step S312 is executed, the step of storing the attribute value in the reward data output device (S391) is conducted. Here, the attribute values which are input are available in two kinds; a service grade and an advantage grade which are the same as the previous ones.

Furthermore, instead of steps S314 of FIG. 9, the step such that the stored information in the reward data output device is output so as to be supplied to the event control apparatus 82 (S392) is conducted.

As described above, an output operation of the event data is conducted.

There will be explained the event information control apparatus 82.

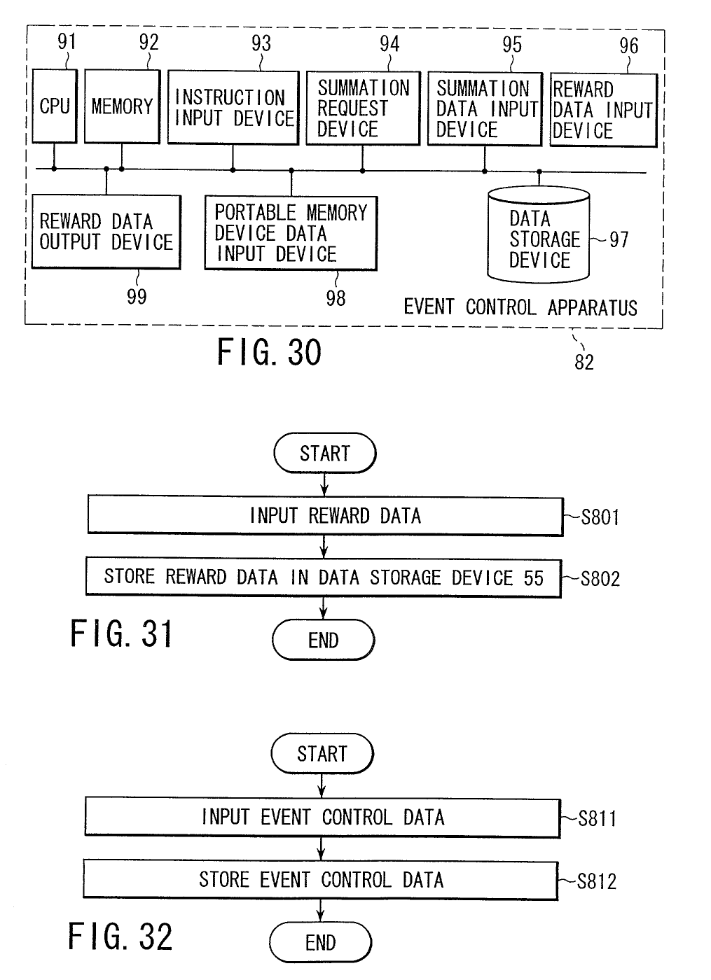

FIG. 30 is a diagram showing a functional block structure inside of the event control apparatus 82.

The event control apparatus 82 includes a CPU 91, memory 92, and instruction input device 93 such as a mouse, a keyboard or the like. Furthermore, the event control apparatus 82 includes a summation information request device 94 for designating an output of summation information from the summation apparatus 87, summation information input device 95 for inputting summation information based on this request, and summation information input device 96 for inputting reward data output from the event production apparatus 81. Furthermore, the event control apparatus 82 includes a data storage device 97 for storing input reward data.

Furthermore, there are provided a portable memory device information input device 98 and reward data output device 99 connected to the shop apparatuses 86 via the network in a communicative manner. When receiving the information of the portable memory device from the shop apparatus 86, the portable memory device information input device 98 inputs information of the portable memory device output from the shop apparatus 86. The reward data output device 99 refers to a portion for referring to event control data input at the instruction input device 93 by the scenario producer under the control of the CPU 91, judging the reward data to be output, and supplying the information to the shop apparatus 86 to which the information is sent.

The event control apparatus 82 having the above function can be realized on a normal computer system.

A method of storing reward data of the event control apparatus 82 is as shown in FIG. 31. That is, the supply of the reward data output from the event data production apparatus 81 is input with the reward data input device 96 (S801) and the input reward data is stored in the data storage device 97 (S802). In this manner, the reward data is stored in the event control apparatus 82.

A method of inputting control data to the event control apparatus 82 is, as shown in FIG. 32, carried out in such a manner that the scenario producer inputs the event control data by using the input device 93 while watching the display device (not shown) of the event control apparatus (S811).

As the event control data input here, a command sequence is input which represents: reward data of advance grade 4 is supplied to those who bring a portable memory device storing the program ID of XXXX from Jan. 1, 2001 to Jan. 3, 2001, reward data of service grade 2 is supplied to those who has an individual ID of the prize-winning number, and all the advance grade 5 is supplied to the ten thousandth person having the event ID information of VHKJ.

The event control apparatus 82 stores the event control data input in this manner (S812).

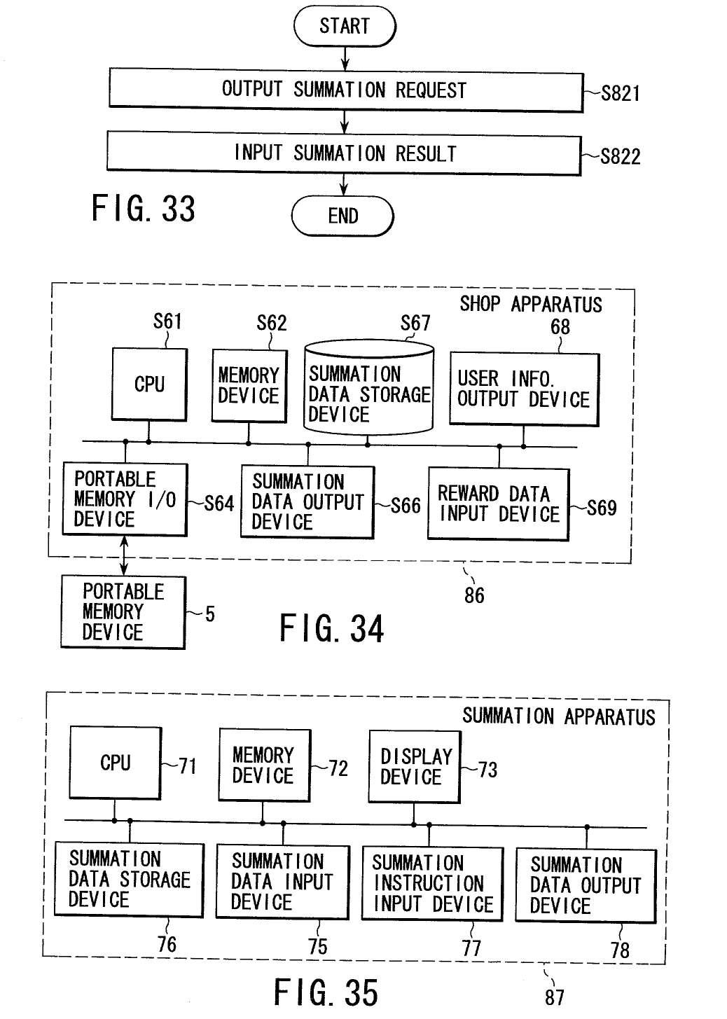

The event control apparatus 82 makes a summation request to the summation apparatus 87 as shown in FIG. 33 (S821), and obtains the result of summation request (S822) from the summation apparatus 87. As a timing of making this summation request, the scenario producer makes a request at the instruction input device 93 when the scenario producer wants to see the summation. In addition, the summation apparatus is sometimes used also in the case where the reward data which should be output can be used.

Next, the shop apparatus 86 will be explained.

FIG. 34 is a diagram showing a functional block structure inside of the shop apparatus 86. The shop apparatus 86 is different from the shop apparatus 6 of the first embodiment in its role. In the shop apparatus 6, the reward data is stored and the required reward data is determined and supplied. The shop apparatus 86 has a function of a relay device for supplying the reward data provided in the event control apparatus 82.

A summation information storage device 67 stores information (information on usage customers) associated with the user customer using the shop apparatus 86.

A user information output device 68 transmits to the event control apparatus 82 information of the portable memory device 5 read via the portable memory device I/O device 64 to the event control apparatus 82.

After a reward data input device 69 transmits the information of the portable memory device 5 with the user information output device 68, the reward data which should be written from the event control apparatus 82 to the portable memory device 5 is received. The input reward data is written into the portable memory device 5 with the portable memory device I/O device 64.

The block structure of the summation apparatus 87 is shown in FIG. 35 and will be explained. In the summation apparatus 7 of the first embodiment, the instruction of the summation is input with the instruction input device 74 in the apparatus 7. However, in the summation apparatus 87 of the second embodiment, a summation instruction request can be received from the event control apparatus 82 to conduct summation based on the instruction and send the summation result to the event control apparatus.

A summation instruction input device 77 receives a request of summation information from the event control apparatus 82.

In accordance with the received summation instruction, the summation apparatus 87 conducts summation under the control of a CPU 71. Then, the summation result is output with the summation information output device 78.

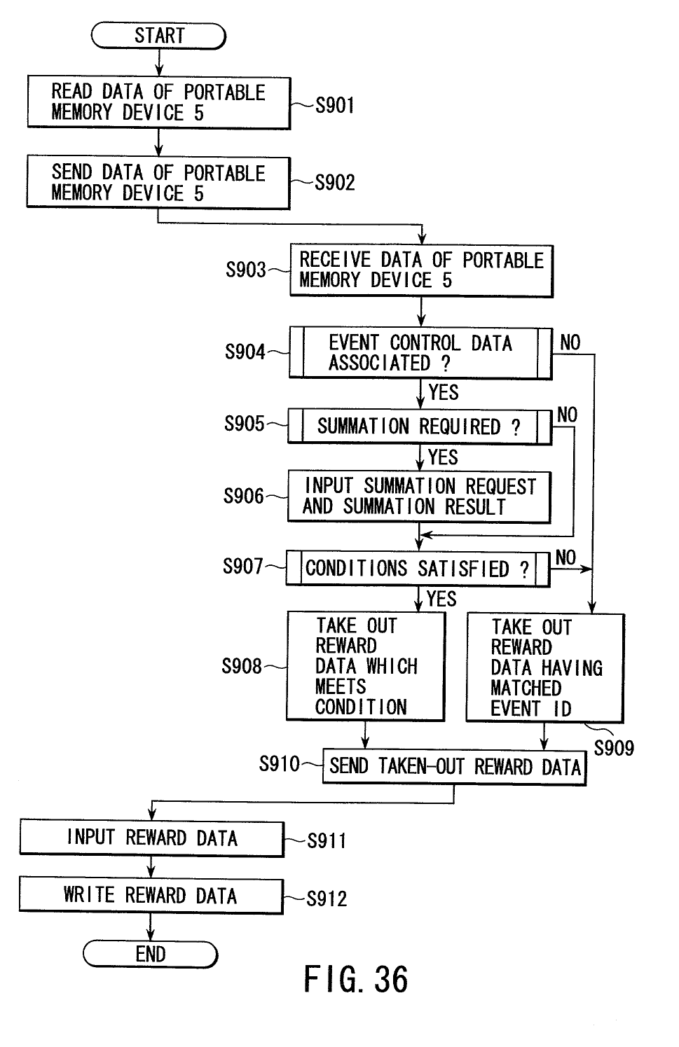

An operation flow of the event control apparatus 82 and the shop apparatus 86 will be shown in FIG. 36.

In the same manner as the first embodiment, the user who sees the advertisement brings the portable memory device 5, visits the shop and connects the portable memory device 5 to the shop apparatus 86. The shop apparatus 86 reads the information (the apparatus ID and the memory content) of the connected portable memory device 5 (S901). The shop apparatus 86 communicates with the event control apparatus 82 to send the read information of the portable memory device 5 to the event control apparatus 82 (S902).

When the event control apparatus 82 receives the sent information of the portable memory device 5 (S903), in the beginning, it is determined whether or not the stored event control data includes information associated with this received information of the portable memory device 5 (S904).

In the case where the associated event control data is present, it is determined whether or not the summation information is required for the event control data (S905). Only in the case where the summation information is required, the event control apparatus 82 makes a request of the supply of the summation information to the summation information 87. Then, the summation information is input to the summation apparatus 87 to obtain the summation information (S906).

The event control apparatus 82 determines whether or not the condition of the event control data is satisfied based on the summation information in accordance with the information of the portable memory device 5 and the summation information as needed (S907). When the conditions are satisfied, the reward data that coincides with the condition is taken out from the data storage device 97 (S908).

On the other hand, at step S904, in the case where it is determined that the event control data are not associated, or at step S907, in the case where it is determined that the conditions of the event control data are not satisfied, normally, the reward data that agrees is taken out from the data storage device 97 with the event ID information which is one item of information of the portable memory device 5 received at step S903 (S909). The event control apparatus 82 sends the taken out reward data with the reward data output device 99 (S910).

The shop apparatus 86 inputs the reward data sent from the event control apparatus 82 in the reward data input device 96 (S911), and writes the reward data to the portable memory device 5 (S912).

In the above explanation, in the case where the reward data is not stored, the expression particularly on the flowchart is omitted. However, at step S910, instead of sending the reward data to the shop apparatus 86, for example, information may be sent which shows the absence of the reward data.

As has been explained above, in the second embodiment, in addition to the effect obtained in the first embodiment, even after the reward data is temporarily output, the condition of supplying the reward data can be changed by giving the event control data. This means that it is possible to make a plan of thanks giving day held at ordinary shops, that is, it is possible to supply not only an item but also an additional item which obtains reward data in a certain period. Furthermore, it is possible to limit the condition of supplying the amount of the supply of the reward data, namely, the supply amount of the reward data. In this case, for example, it is considered that when the condition is set, for example, to such condition; the items will be ten thousand people who go first, the user responds to such a condition and the effect of gathering customers will be improved.

In this manner, the supply of the reward data can be controlled so that the advertisement system is even more fascinating, in particular, for shop clerks. With an increase in the value of the advertisement system, a chance will be provided to the scenario producer of obtaining a big business.

As has been explained above, it has become possible to provide a favorable electronic advertisement provided both with the exposure effect and guide effect, to reproduce the provided electronic advertisement.

Furthermore, the present invention can be practiced as a computer readable recording medium in which a program for allowing the computer to function as predetermined means, allowing the computer to realize a predetermined function, or allowing the computer to conduct predetermined means.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A method of producing advertisement information comprising:
producing event information for presenting advertisement during an execution of a program, reward data for supplying an additional function to the program and event identification information for identifying the reward data and the event information;
outputting the event information and the event identification information which correspond to each other; and
outputting the reward data and the event identification information which correspond to each other.

2. The method according to claim 1, wherein the reward data includes information for effecting currently ineffective function included in the program.

3. The method according to claim 1, wherein the reward data includes an additional program incorporated in the program.

4. The method according to claim 1, wherein the reward data includes another event information different from said produced event information.

5. The method according to claim 1, wherein the event information includes first event information for presenting a first advertisement during the execution of the program; and
the reward data includes second event information for presenting a second advertisement during the execution of the program.

6. A method of producing a program including event information for presenting advertisement, comprising:
inputting a program which does not include advertisement information;
inputting event information for presenting an advertisement, and event identification information for identifying the input event information; and
inserting, at a predetermined position of the program, the event information, the event identification information and a command for writing out the event identification information to a memory device detachably connected to a program execution apparatus.

7. A method of executing a program, comprising:
presenting an advertisement to a user based on event information included in a program during an execution of the program; and
outputting event identification information corresponding to the event information to an outside of a program executing apparatus.

8. The method according to claim 7, further comprising:
inputting reward data corresponding to the output event identification information; and
executing a program using the input reward data.

9. A method of supplying reward data, comprising:
inputting event identification information and reward data which correspond to each other;
storing the input event identification information and reward data;
reading event identification information from a detachable memory device to compare the read event identification information with the stored event identification information; and
reading the stored reward data corresponding to the read event identification information to write the read reward data into the detachable memory device when the read event identification information coincides with the stored event identification information.

10. The method according to claim 9, further comprising:
inputting a control condition for each of the event identification information associated with an output of the stored reward data;
storing the input control condition; and
determining, based on the control condition, whether or not the reward data corresponding to the event identification information read from the memory device is allowed to be written into the memory device at the time of writing the reward data.

11. An advertisement method comprising:
producing event information for producing advertisement to be presented during an execution of a program, reward data for supplying an additional function to the program and event identification information for identifying the event information and the reward data;
inserting the event information and the event identification information which correspond to each other into the program;
writing the event identification information and event information which are correspond to each other into a detachable memory device;
outputting, when advertisement is presented based on the event information during the execution of the program, the event identification information which corresponds to the event information; and
supplying the reward data which corresponds to the event information to an owner of the detachable memory device storing the event identification information which coincides with the output event identification information.

12. An apparatus of producing advertisement information comprising:
an event information production device which presents advertisement during an execution of a program, reward data for supplying an additional function to the program and event identification information for identifying the reward data;
a first output device which outputs the event information and the event identification information which correspond to each other; and
a second output device which outputs the reward data and the event identification information which correspond to each other.

13. The apparatus according to claim 12, wherein the event information includes first event information for presenting a first advertisement during the execution of the program; and
the reward data includes second event information for presenting a second advertisement during the execution of the program.

14. An apparatus of producing a program including event information for presenting advertisement, comprising:
a first input device which inputs a program which does not include advertisement information;
a second input device which inputs event information for presenting an advertisement, and event identification information for identifying the input event information; and
an insertion device which inserts, at a predetermined position of the program, the event information, the event identification information and a command for writing out the event identification information to a memory device detachably connected to the apparatus.

15. An apparatus of executing a program, comprising:
a presenting device which presents an advertisement to a user based on event information included in a program during an execution of the program; and
an output device which outputs event identification information corresponding to the event information to an outside of the apparatus.

16. The apparatus according to claim 15, further comprising:
an input device which inputs reward data corresponding to the output event identification information; and
an execution device which executes a program using the input reward data.

17. An apparatus of supplying reward data, comprising:
an input device which inputs event identification information and reward data which correspond to each other;
a storage device which stores the input event identification information and reward data;
a first reading device which reads event identification information from a detachable memory device to compare the read event identification information with the stored event identification information; and
a second reading device which reads the stored reward data corresponding to the read event identification information to write the read reward data into the detachable memory device when the read event identification information coincides with the stored event identification information.

18. The apparatus according to claim 17, further comprising:
an input device which inputs a control condition for each of the event identification information associated with an output of the stored reward data;
a storage device which stores the input control condition; and
a determination device determines, based on the control condition, whether or not the reward data corresponding to the event identification information read from the memory device is allowed to be written into the memory device at the time of writing the reward data.

19. An advertisement apparatus comprising:
an event information production device which produces advertisement to be presented during an execution of a program, reward data for supplying an additional function to the program and event identification information for identifying the event information and the reward data;
an insertion device which inserts the event information and the event identification information which correspond to each other into the program;
a writing device which writes the event identification information and event information which are correspond to each other into a detachable memory device;
an output device which outputs, when advertisement is presented based on the event information during the execution of the program, the event identification information which corresponds to the event information; and
a supply device which supplies the reward data which corresponds to the event information to an owner of the detachable memory device storing the event identification information which coincides with the output event identification information.

20. An article of manufacture comprising a computer usable medium having computer readable program code means embodied therein, the computer readable program code means comprising:
computer readable program code means for causing a computer to produce event information for presenting advertisement during an execution of a program, reward data for supplying an additional function to the program and event identification information for identifying the reward data;
computer readable program code means for causing a computer to output the event information and the event identification information which correspond to each other;
computer readable program code means for causing a computer to output the reward data and the event identification information which correspond to each other.
